(19) United States
(12) Patent Application Publication
(10) Pub. No.: US 2024/0217621 A1
(43) Pub. Date: Jul. 4, 2024

(54) TRACTION MECHANISM UNIT, SINGLE OR MULTI-TRACK VEHICLE WITH TRACTION MECHANISM UNIT, METHOD FOR ASSEMBLING AND OPERATING A VEHICLE, METHOD FOR AVOIDING PEDAL KICKBACK IN A VEHICLE, METHOD FOR TRANSMITTING A DRIVE TORQUE OF A SINGLE OR MULTI-TRACK VEHICLE, AND METHOD FOR ELIMINATING INTERACTION BETWEEN A DRIVE TRAIN WITH A TRACTION MECHANISM UNIT AND A SUSPENSION/DAMPING DEVICE IN A SINGLE OR MULTI-TRACK VEHICLE

(71) Applicant: KILLWATT GMBH, Tirschenreuth (DE)

(72) Inventors: Hans Peter ACKERMANN, Tirschenreuth (DE); Volker ACKERMANN, Tirschenreuth (DE); Marian LUKAC, Zvolen (SK)

(21) Appl. No.: 18/558,063

(22) PCT Filed: Apr. 26, 2022
(86) PCT No.: PCT/EP2022/061055

§ 371 Date: Oct. 30, 2023

(30) Foreign Application Priority Data
Apr. 30, 2021 (DE) 10 2021 111 293.1

(51) Int. Cl. B62M 9/16; B60B 27/02; B62J 6/00; B62J 13/04; B62J 45/41; B62J 45/412; B62K 25/28; B62L 1/02; B62M 6/55; B62M 9/02

(52) U.S. Cl. CPC B62M 9/16; B60B 27/026; B62J 6/00; B62J 13/04; B62J 45/41; B62J 45/412; B62K 25/286; B62L 1/02; B62M 6/55; B62M 9/02

(57) ABSTRACT

A vehicle with a traction mechanism unit, a method for assembling a vehicle, a method for avoiding pedal kickback in a vehicle, a method for transmitting a drive torque of a single-track or multi-track vehicle via a traction mechanism unit, and a method for eliminating interaction between a drive train with a traction mechanism unit and a suspension/damping device in a single-track or multi-track vehicle, and a corresponding traction mechanism unit.

The invention relates to a traction mechanism unit for a single- or multi-track vehicle, in particular a bicycle, pedelec, e-bike or bicycle with auxiliary drive, and to a single- or multi-track vehicle, in particular a bicycle, pedelec, e-bike or bicycle with auxiliary drive. Moreover, the invention relates to a method for assembling a vehicle, a method for avoiding pedal kickback in a vehicle, a method for transmitting a drive torque of a single-track or multi-track vehicle via a traction mechanism unit, and a method for eliminating interaction between a drive train with a traction mechanism unit and a suspension/damping device in a single-track or multi-track vehicle.

Generic vehicles include, for example, single- or multi-track vehicles such as bicycles, in particular electric bicycles, e-bikes or pedelecs. In particular, generic vehicles include vehicles of vehicle categories L1e, L2e, L3e, L4e, L5e, L6e and L7e according to Article 4 of EU Regulation 2013/168/EU of Jan. 15, 2013. Further, they include in particular vehicles designed for a maximum speed of up to 6 km/h, vehicles intended exclusively for use in sporting competition, pedal-driven bicycles with pedal assistance, which are equipped with an electric motor-based auxiliary drive with a maximum continuous rated power of up to 250 W, the assistance of which is interrupted when the rider stops pedaling and the assistance of which progressively decreases as the vehicle speed increases and is interrupted before the speed of the vehicle reaches 25 km/h, self-balancing vehicles with electric motor-based propulsion, pedal-propelled sports vehicles, pedal-propelled vehicles that do not have at least one seat, and pedal-propelled vehicles with an R-point (according to ECE-R 17)≤400 mm. Cargo bikes also fall under this category. They frequently have a front wheel and at least one rear wheel connected by a frame. However, there may also be multiple rear wheels, for example two rear wheels, and/or multiple front wheels, for example two front wheels, and in particular any combination thereof. These wheels may, for example, be arranged side by side transversely to a forward direction of travel, such as on a tricycle or a vehicle with a sidecar, or one behind the other in a forward direction of travel, such as on a tandem. The front wheel is typically mounted for rotation about a front wheel axis and the rear wheel is mounted for rotation about a rear wheel axis. Such vehicles are increasingly equipped with at least one electric motor to assist the user in propelling the vehicle. Typically, they are not powered by this electric motor alone, but the electric motor assists the user in propelling the vehicle from their own human muscle strength. In most cases, the degree of assistance is selectable. In this way, a user can apply exactly as much of his own power as he can or wants to while riding such a vehicle, while still moving at a comfortable speed usable in everyday life. Moreover, generic vehicles may also be autonomous vehicles, i.e., vehicles that can be operated without active control input from a driver.

Generic vehicles typically have at least one traction means with which drive energy derived from human muscle strength and/or a drive system, for example an electric motor, can be transmitted to at least one driven wheel, for example at least one rear wheel or at least one front wheel. Chains and/or belts are typically used as the traction means. Both traction means have their advantages and disadvantages. For example, chains typically cause increased wear resulting in comparatively low service lives. Belts, on the other hand, have a significantly longer service life, but require a very high pretension to enable proper force transmission. The associated tensioning forces usually have to be absorbed by the frame of the vehicle.

CN 109 533 163 A describes a generic vehicle, in particular a folding bicycle, which has a generic traction mechanism unit for transmitting the drive energy. The traction mechanism unit comprises an input traction means driven by an input traction means pulley and an output traction means driving an output traction means pulley. The input traction means pulley thus represents the “force input” and the output traction means pulley represents the “force output” toward the driven wheel. In the case of CN 109 533 163 A, the input traction means is a chain and the output traction means is a belt. The input and output traction means are arranged in series with each other and are in transmission connection with each other via a transmission traction means pulley unit. The transmission traction means pulley unit has an input-side traction means pulley engaged with the input traction means and an output-side traction means pulley engaged with the output traction means, the input traction means pulley and the output traction means pulley being rotatable coaxially with respect to each other. The input-side traction means pulley and the output-side traction means pulley are arranged in a co-rotating manner. The input traction means pulley is driven by a drive shaft connected to pedals and/or a drive unit, thereby driving the input traction means, which drives the output traction means via the transmission traction means pulley unit, which in turn drives the output traction means pulley, which is in drive connection with the rear wheel or the front wheel, thereby initiating a propulsive movement.

The structure of the vehicle and the traction mechanism unit known from the prior art entails several disadvantages. On the one hand, all gear or transmission elements are mounted stationary on the frame of the vehicle. This results in the traction means being tensioned between these gear elements fixed to the frame. As a result, the tensioning forces generated by the pretensioning of the traction means are introduced into the frame, which must be compensated for by the frame with a correspondingly heavy, robust and inflexible design, especially if belts are used as the traction means. Since the frame of the conventional vehicle is used to absorb the pretensioning forces of the traction means, the traction means can be pretensioned only after they have been mounted on the frame and thus on the vehicle. This, together with the fact that all the gear elements also need to be fixed to the frame separately, results in an overall increase in assembly work for the gear units of the prior art. The high pretensioning forces required for the use of belts cannot typically be realized at all by the end user in practice and thus involve increased maintenance requirements. In addition, displacements of the center distance between the drive axis and the axis of the driven rear wheel caused by compression motions of the rear wheel relative to the frame have so far had to be compensated for by additional tensioning elements for the traction means, for example separate chain tensioners. If the traction means are also to be tensioned during a braking operation of the vehicle, for example in order to recover drive energy via recuperation, two such tensioning elements would have to act on the traction means, as driving and slack sides alternate here. Due to the high complexity and high costs, this is therefore typically not implemented.

Against this background, it is the object of the present invention to reduce or eliminate the disadvantages of the prior art. Accordingly, an improved traction mechanism unit and a vehicle with an improved gear unit are to be provided. In particular, the aim is to simplify assembly and operation of the vehicle and, in particular, the gear unit.

The object is achieved with a traction mechanism unit, a vehicle and any one of the methods according to the independent claims. Preferred embodiments are cited in the dependent claims.

Specifically, for a generic traction drive unit mentioned above, the object is achieved in that a first support unit supporting the input traction means pulley and the input-side traction means pulley is provided for absorbing the tensioning forces of the input traction means, and a second support unit supporting the output traction means pulley and the output-side traction means pulley is provided for absorbing the tensioning forces of the output traction means. The first support unit and the second support unit are additionally configured to rotate separately from or relative to each other, in particular about the transmission traction means pulley unit. An essential core idea of the invention is therefore that the traction mechanism unit itself is configured such that the tensioning forces or pretensioning forces of the traction means used, i.e. the input traction means and the output traction means, are absorbed by their own support units, which are not part of the frame of the vehicle. This makes it possible to decouple the tensioning forces required for operation of the traction means from torques to be transmitted via the traction mechanism unit, which in particular brings the advantages described in more detail below. Irrespective of the particular vehicle, the traction means unit according to the invention thus represents an independent structural unit which also absorbs the tensioning forces required for tensioning the respective traction means. The support units are thus part of the traction mechanism unit itself, so that the latter can be arranged or mounted on the frame of the vehicle in a practically tension-free manner. The first support unit and the second support unit fully absorb the tensioning forces or pretensioning forces of the input traction means and the output traction means. The support units therefore prevent the tensioning forces from being introduced into the frame. The input traction means pulley, the output traction means pulley and the transmission traction means pulley are rotatably mounted in the respective support units so that the traction means rotating around the traction means pulleys can transmit a rotary motion about the respective axes in a manner known per se. In addition, however, the two support units are also rotatable relative to each other, in particular about the rotation axis of the transmission traction means pulley unit. The ability of the support units to rotate relative to one another means that the distance between the input traction means pulley and the output traction means pulley or their rotation axes can be adapted to structural conditions of the respective vehicle and/or also dynamically during operation, for example during rear wheel suspension compressions, as will be explained in more detail below. Ultimately, this gives the traction mechanism unit a degree of freedom of movement in a plane perpendicular to the rotation axis of the input and output traction means pulleys. At this point it is important to emphasize that by such a rotation of the two support units with respect to each other, i.e., by changing the angular position of the two support units with respect to each other, the tension of the traction means per se is not affected. As will be shown in more detail below, this approach makes it possible, in a completely novel way, to dispense entirely with elements that “retighten” the traction means during operation, such as usually a chain tensioner. The fact that the distance between the input traction means pulley and the output traction means pulley can be varied also considerably simplifies the assembly of the traction mechanism unit.

Another essential idea is that the traction mechanism unit according to the invention is configured as an independent, coherent structural unit that can be easily carried by a person, in particular, with traction means already finally tensioned in this unit independently of an installation in a vehicle. The traction gear thus represents an optimally versatile functional module that can be adapted easily and without further effort to various center distances between an input rotation axis and an output rotation axis in a vehicle of the type described above. In terms of scale, the traction mechanism unit is therefore preferably in a weight range of less than 5 kg, in particular less than 3 kg. Furthermore, it offers the possibility of providing a drive train, preferably self-contained except for the input and output connection points, which can be provided preassembled and practically ready for use without requiring any significant individual adaptation measures on the vehicle.

The support units can thus be elements which, on the one hand, allow a rigid spacing of the rotation axes of the input traction means pulley and the transmission means pulley unit and, on the other hand, allow a rigid spacing of the rotation axes of the output traction means pulley and the transmission means pulley unit and which, at the same time, absorb tensioning forces required to tension or maintain the tension of the respective traction means. For this purpose, the support units obviously have a stability which is at least sufficient to absorb not only the tensioning forces introduced via the traction means but at the same time also the driving forces introduced by the drive system. For this, the support units preferably both extend longitudinally along a longitudinal axis between the respective rotation axes and are in particular configured in a web-like manner, more particularly also in pairs.

Within the traction mechanism unit, the drive energy is transmitted from the input traction means pulley to the input traction means. From the input traction means, the drive energy is then transferred to the input-side traction means pulley of the transmission traction means pulley unit, which in turn transfers it to the output traction means pulley. The output-side traction means pulley drives the output traction means pulley via the output traction means. Thus, the at least two traction means are arranged in series, i.e., are functionally arranged one behind the other in a direction of force transmission. Preferably, the input-side traction means pulley and the output-side traction means pulley of the transmission traction means pulley unit are coaxial with each other. For this purpose, the transmission traction means pulley unit preferably has a transmission axis, with the input-side traction means pulley and the output-side traction means pulley being arranged coaxially to the transmission axis. At the same time, the transmission axis also preferably represents the rotation axis about which the first support unit and the second support unit are configured to pivot relative to each other. The transmission axis therefore implements, in other words, the ‘knee’ between the two support units, so to speak.

The transmission of the drive energy from the input-side traction means pulley to the output-side traction means pulley can basically be implemented in various ways and may, for example, take the form of a wide variety of gears. For example, additional gear elements might be arranged to transmit the drive energy between the two traction means pulleys. However, it is preferred if the input-side traction means pulley and the output-side traction means pulley are configured in a co-rotating manner with respect to each other. Particularly preferably, they are configured as one integral piece. The input-side traction means pulley and the output-side traction means pulley then together form one integral component. The transmission traction means pulley unit may thus also be implemented as an integral component that is connected to both the input traction means and the output traction means.

As will be explained in more detail below, the traction mechanism unit according to the invention can be used to significantly minimize or eliminate mutual interference between drive and suspension (“antisquat”) in generic vehicles, typically bicycles, while at the same time providing increased construction freedom, in particular to the extent that an optimization of antisquat is possible independently of the intersection point of the traction means line with the antisquat line known per se in the prior art. Additionally or alternatively, the undesirable effect of “pedal kickback” can also be effectively counteracted. For this purpose, it may be preferred if the transmission ratio from the input-side traction means pulley to the output-side traction means pulley and/or from the input traction means pulley to the output traction means pulley and/or from the input traction means pulley to the input-side traction means pulley and/or from the output-side traction means pulley to the output traction means pulley is one to one. Generally, larger or smaller transmission ratios can of course also be used here. However, a one-to-one ratio is preferred. In particular, in the case where the traction means pulleys of the transmission traction means pulley unit, i.e., the input-side traction means pulley and the output-side traction means pulley, have a same effective radius as the input traction means pulley and the output traction means pulley, pedal kickback can be fully compensated. In this case, there will also be a one-to-one ratio between these traction means pulleys. The effective radius is in this case the radial distance from a circumferential surface of the traction means pulley in contact with the traction means to the rotation axis. However, the invention also makes it possible to set any desired pedal kickback. If, for example, the effective radii of the input-side traction means pulley and the output-side traction means pulley, i.e., the transmission traction means pulley unit, are smaller than the effective radii of the input traction means pulley and the output traction means pulley, a so-called positive pedal kickback, i.e., a pedal kickback directed against the pedaling direction, occurs in the case of a compression at the driven wheel, for example the rear wheel. If, on the other hand, the effective radii of the input-side traction means pulley and the output-side traction means pulley are larger than the effective radii of the input traction means pulley and the output traction means pulley, for example, a so-called negative pedal kickback, i.e., a pedal kickback directed in the direction of pedaling, occurs in the case of a compression at the driven wheel. In summary, it can thus be stated that the traction mechanism unit according to the invention particularly advantageously allows a variation of the transmission ratio and thus, in particular with regard to so-called pedal kickback, practically enables an “adjustment” of the pedal kickback toward an individual behavior, comprising an elimination of pedal kickback or also the adjustment of any desired pedal kickback behavior.

This does not necessarily require a transmission ratio of one to one from the input-side traction means pulley to the output-side traction means pulley. In particular, for fast vehicles, such as racing bicycles, it may be preferred to have a speed-increasing transmission ratio from the input-side traction means pulley to the output-side traction means pulley. For example, transmission ratios of 1 to 1-1.5 may be used here. Here, too, however, pedal kickback can be completely or at least almost completely avoided with the traction mechanism unit according to the invention, so that it becomes negligible in practice. To implement a speed-increasing transmission ratio toward the output-side traction means pulley, the number of teeth or the diameter of the input-side traction means pulley must be greater than the number of teeth or the diameter of the output-side traction means pulley. In order to eliminate or reduce pedal kickback even with such a transmission ratio, it has been shown that the number of teeth or the diameter of the transmission traction means pulley unit, i.e., the input-side traction means pulley and the output-side traction means pulley, should be between the number of teeth or the diameter of the input-side traction means pulley and the output-side traction means pulley, which thus constitutes a preferred embodiment of the invention for a speed-increasing transmission ratio. In this way, the transmission traction means pulley unit compensates for pedal kickback imposed by the input-side traction means pulley and the output-side traction means pulley. For example, pedal kickback is reduced to near zero in the case of a tooth count of 46 for the input-side traction means pulley, a tooth count of 36 for the output-side traction means pulley and a tooth count of 40 for the transmission traction means pulley unit.

In this context, it is thus essential in particular that the transmission traction means pulley unit is supported exclusively via the first support unit and the second support unit. Thus, in particular, no fastening device is provided on the transmission pulley unit itself or in the region thereof, with which a rigid fastening to a frame of the vehicle is to be effected. Supporting the transmission traction means pulley unit exclusively via the first and second support units ensures that the tensioning forces of the traction means are actually absorbed by the support units in order to transmit the traction forces of the traction means between the torque input and torque output, for example between a pedal axis and/or motor axis and a front or rear axle, completely without any feedback effects.

In order to keep wear on the traction means as low as possible and also to exclude the risk of injury by the moving traction means, it is preferred for the input traction means and the output traction means to be shielded from the outside or encapsulated. For this purpose, a housing is preferably provided, in the interior of which the traction means run. The task of the housing is thus first of all to form a physical barrier that protects the traction means from external influences, such as dirt. It is preferred if the housing is stationary relative to the support units. Ideally, the first support unit has a first housing and/or the second support unit has a second housing, the housing(s) encapsulating or enclosing the input traction means and the output traction means, respectively, in particular completely, possibly with further involvement of one or more traction means pulleys. Encapsulation according to the invention is not necessarily considered to be a complete, for example airtight, enclosure of the traction means. Another advantage of using a housing is that the risk of injury is significantly reduced. For this purpose, it is preferred that the housing is at least configured such that it does not have any openings through which an operator could reach with a finger or hand. It is particularly preferred if the housing has at least essentially closed surfaces, at least around the traction means. With regard to the choice of materials, different variants may be used. However, the first and/or the second housing are at least preferably made of plastic. Between the first housing and the second housing, which move in relation to each other particularly when the support units rotate about the transmission traction means pulley unit, one or more sealing means may be provided to ensure complete encapsulation of the traction means even when the housings move relative to each other. Such a sealing means may be, for example, an elastic sealing element and/or a labyrinth seal or the like. Even if the respective housings are constructed from multiple parts, such sealing means may be provided between the individual parts.

The housing is preferably made of several parts. In particular, the first housing and/or the second housing may each have, in particular exactly, two housing halves or two housing shells which are configured to be complementary to one another in an abutment region and together form the accommodating interior, in particular for the traction means.

Generally, the support units may, in addition to the housing or also without the housing, have a separate force-absorbing part configured to absorb the tensioning forces of the traction means, for example a material web or the like. However, it is particularly preferred to dispense with such a force-absorbing part separate from the housing. It is therefore preferred if the first support unit is formed, in particular completely, by the first housing itself, so that this first housing is configured to absorb the tensioning forces of the input traction means, in particular completely. Additionally or alternatively, it is preferred that the second support unit is formed, in particular completely, by the second housing, so that this second housing is configured to absorb the tensioning forces of the output traction means, in particular completely. Very preferably, the first housing and the second housing fully absorb the tensioning forces of the input traction means and the output traction means. A separate force-absorbing part is therefore not necessary. In this case, the respective support unit is completely formed by the respective housing. In this case, the housing thus fulfills a dual function and, in addition to shielding the traction means, also serves to absorb the tensioning forces required to tension the traction means. In this context, use may also be made of a composite structure such that additional support elements are incorporated in the housing in order to be able to absorb the tensioning and transmission forces required for the use of the traction mechanism unit.

For setting the pretension of the input traction means and the output traction means, the options known in the prior art for this field of application may generally be considered. Preferably, the traction mechanism unit has at least one traction means tensioner and in particular one traction means tensioner per traction means. According to a preferred embodiment, the first support unit may have a first traction means tensioner for pretensioning the input traction means and/or that the second support unit has a second traction means tensioner for pretensioning the output traction means. The first and/or the second tensioner may, for example, be a linearly adjustable tensioning unit configured such that it can be used to adjust the distance of the rotation axes between the input traction means pulley or the output traction means pulley and the transmission traction means pulley unit along an essentially linear adjustment curve. However, it is preferred if the tensioning unit is configured as an eccentric traction means tensioner. The respective support unit thus has an eccentrically shaped ring arranged coaxially to the respective traction means pulley, which is accessible from outside the traction mechanism unit via a pretensioning access. By rotating this eccentric traction means tensioner, the distance between the input traction means pulley and the input-side traction means pulley or the output-side traction means pulley and the output traction means pulley is changed, in particular increased, as a result of which the input traction means and the output traction means, respectively, are pretensioned. The traction means tensioner of the first support unit may be arranged on the input traction means pulley or the input-side traction means pulley, for example. The traction means tensioner of the second support unit may be arranged, for example, on the output-side traction means pulley or the output traction means pulley.

Preferably, the traction means tensioner of the first support unit is arranged on the input-side traction means pulley and the traction means tensioner of the second support unit is arranged on the output-side traction means pulley. In other words, it is preferred that the first and/or second traction means tensioners are arranged on the transmission traction means pulley unit. As already mentioned, there is in particular at least one pretensioning access through which the first and/or the second traction means tensioner can be accessed from the outside for adjusting a pretensioning position. Particularly preferably, each traction means tensioner has at least one such pretensioning access. The traction means tensioners can be used to adjust the tension of the traction means even before the traction mechanism unit is mounted on the vehicle. This is made possible by the fact that the traction mechanism unit includes the support units to absorb the tensioning forces and does not need to rely on introducing the tensioning forces into the frame of the vehicle. This makes it possible to set the pretension of the traction means already at the factory, so that end users will not need any special tools even if they install the traction mechanism unit on their vehicle themselves. In addition, no special expertise is required.

The exact arrangement of the traction means tensioners is variable. For example, the transmission traction means pulley unit may be mounted on the first support unit or the first housing and/or the second support unit or the second housing via a rotary bearing, for example a roller bearing. It is now preferred that the first and/or the second traction means tensioner are arranged inside or outside this rotary bearing. Inside or outside means in this case on the inner side, seen radially with respect to the transmission axis, or on the outer side, seen radially with respect to the transmission axis, of the rotary bearing. Seen from radially outward to inward with respect to the transmission axis, the contact surface of the input-side traction means pulley or the output-side traction means pulley for the respective traction means are thus followed by the traction means tensioner, which is followed by the rotary bearing. This describes the arrangement of the traction means tensioner outside the rotary bearing. Alternatively, seen from radially outward to inward with respect to the transmission axis, the contact surface of the input-side traction means pulley or the output-side traction means pulley for the respective traction means are preferably followed by the rotary bearing and then the traction means tensioner. This describes the arrangement of the traction means tensioner inside the rotary bearing. The described arrangements of the traction means tensioner each have structural advantages that can be selected depending on the specific application.

In particular, chains and belts can be used as traction means in the present invention. However, it is particularly preferred if the input traction means and/or the output traction means are configured as belts, in particular toothed belts. Since, according to the invention, the tensioning forces of the traction means are absorbed by the support units, the invention avoids the difficulties associated with the application of high tensioning forces of belts commonly found in the prior art, as due to the fact that, for example, the comparatively high tensioning forces are absorbed by the first and second support units, special configurations of the frame per se are no longer required. The invention therefore makes it possible to take advantage of the benefits of belts, for example their durability, without the associated disadvantages.

The traction mechanism unit of the invention is also suitable for having a braking device arranged thereon. For example, it is preferred if a braking device with a brake caliper and a brake disc is provided. The brake caliper and/or the brake disc are preferably arranged or mounted on the traction mechanism unit, and together with the latter particularly preferably form a coherent preassembly module. In particular, the brake disc is arranged coaxially with the input traction means pulley or the output traction means pulley or the transmission traction means pulley unit and, in particular, is connected to it in a co-rotating manner. The brake disc therefore rotates with the respective traction means pulley. The brake caliper, on the other hand, is preferably arranged or mounted on the housing of the traction mechanism unit. It is therefore fixed and can be pressed against the brake disc for braking. In this way, bearing forces occurring during braking are diverted into the bearing structure of the traction mechanism unit and, for example, also not into the frame. In addition, this arrangement allows for a much easier maintenance concept, as will be discussed in more detail below.

In cooperation with electronics provided on the vehicle in a preferred embodiment, for example a control device, the traction mechanism unit of the present invention may perform even further functions. For example, it is preferred that the traction mechanism unit comprises a speed sensor, in particular for determining the travel speed of the vehicle. Said sensor may in particular be a Hall sensor. In particular, the speed sensor is arranged on the input traction means pulley or the output traction means pulley or the transmission traction means pulley unit. Moreover, the traction mechanism unit may comprise, for example, a suspension travel sensor that measures a rotation of the support units relative to each other, in particular about the transmission axis. This rotation can be used to infer a compression motion of the rear wheel or the front wheel relative to the frame. For example, the suspension travel sensor may be arranged in the area of the transmission traction means pulley unit and, for example, detect pivoting of the two support units relative to each other about the transmission traction means pulley unit and infer a suspension travel from this. Alternatively, for example, a rotation of the front support unit relative to the frame or relative to the motor may be determined. This permits a particularly compact design, because the sensor may then be positioned in the motor, for example, and the position may be detected, for example, via a magnet that rotates relative to the sensor, i.e., is arranged, in particular stationary, on the front support unit. No cable outside the motor is then required.

Both the speed sensor and the suspension travel sensor may be in signal connection with a control device of the vehicle via a signal cable or also wirelessly. Moreover, the traction mechanism unit may also include an electric generator for recovering drive energy as electric energy. This generator may work in the manner of a dynamo to generate electric energy for the operation of electric components of the vehicle from the energy introduced by human muscle strength.

The present invention provides several ways to configure the traction mechanism unit in the region of the transmission traction means pulley unit. In a preferred embodiment, the transmission traction means pulley unit, and in particular also the housings of the support units, comprise a through-opening which extends through the traction mechanism unit and is open to the outside. The through opening thus completely extends through the traction mechanism unit, such that it is possible to look through from one side to the other. The through opening is in particular coaxial to the transmission axis and is preferably cylindrical along the transmission axis. The through opening is preferably bounded outwardly in the radial direction of the transmission axis by the transmission traction means pulley unit and/or an inner housing, the inner housing preferably being arranged for co-rotation with the transmission traction means pulley unit and being rotatable therewith. Thus, a rotating part of the traction mechanism unit can be viewed from the outside through the through opening when the vehicle is moving. Additionally or alternatively, the through opening may also be at least partially bounded outwardly in the radial direction of the transmission axis by one or both housings of the support units. These do not rotate during operation of the traction mechanism unit, so no rotating parts are visible and accessible from the outside, which increases the safety of the vehicle. Finally, it is also possible that the through opening is closed with covers belonging to one or both housings of the support units. In a preferred embodiment, at least one lighting device is arranged in the region of the through opening, which in particular illuminates the inner housing and/or the transmission traction means pulley unit and/or the cover.

The traction mechanism unit according to the invention thus ideally also comprises two connecting flanges, specifically a first connecting flange on the input traction means pulley or in a co-rotating position therewith and a second connecting flange on the output traction means pulley or in a co-rotating position therewith. The gear connection to or into a drive train of a vehicle, in particular according to the invention, is effected via these two connecting flanges, for example via threaded and/or clamp connections.

The invention further relates to a vehicle, in particular a vehicle having a traction mechanism unit according to the invention as described above. All of the above-described features, effects and advantages of the traction mechanism unit according to the invention also apply mutatis mutandis to the vehicle according to the invention and vice versa. Merely to avoid repetitions, reference is made to the respective other explanations.

For a single- or multi-track vehicle, in particular a bicycle, pedelec, e-bike or bicycle with auxiliary drive, of the generic type, i.e., specifically comprising a front wheel and at least one rear wheel, which are connected to one another via a frame, the front wheel being mounted for rotation about a front wheel axis and the rear wheel being mounted for rotation about a rear wheel axis, and for a traction mechanism unit having at least two traction means, very particularly at least two traction means arranged in series with one another, in particular of a traction mechanism unit according to the invention, according to the invention, the traction mechanism unit may now be configured such that it absorbs tensioning forces of the at least two traction means completely decoupled from the frame and transmits torque forces introduced into the traction mechanism unit via an input traction means pulley to the output traction means pulley isolated from the frame. In contrast to the prior art, the frame is thus decoupled from tensioning forces for the traction means, which significantly simplifies the assembly process in particular, as described in more detail below. At the same time, this arrangement means that traction means forces no longer act horizontally on the rear or front axle as with a conventional chain drive, which ultimately enables decoupling between drive and suspension. This basic approach makes it possible to configure the mutual interference between drive and suspension (antisquat) independently of a specific transmission ratio, because the traction means forces are decoupled and do not act horizontally on the rear axle. Ultimately, the invention thus eliminates interaction between drive forces and suspension, which in turn enables optimization of the antisquat behavior independently of the drive.

In a generic vehicle mentioned at the beginning, the object is thus achieved in other words specifically in that a first support unit supporting the input traction means pulley and the input-side traction means pulley is provided for absorbing tensioning forces of the input traction means independently of the frame, and in that a second support unit supporting the output-side traction means pulley and the output traction means pulley is provided for absorbing tensioning forces of the output traction means independently of the frame. In the present context, the frame of the vehicle is understood to mean all parts of the vehicle that form a supporting structure for, for example, the front wheel(s), the rear wheel(s), a saddle and a handlebar. Typical frame parts according to this definition using the example of a bicycle are therefore, for example, top tube, down tube, seat tube, front fork and/or rear wheel strut or rear wheel swing arm. Such a structure, specifically for bicycles, is also commonly called a bicycle frame. Such frames may partially include suspended elements. For bicycles, for example, it is known that the frame structure toward the rear wheel is rigid with respect to the rest of the frame structure (“main frame”) via the rear wheel strut (“hardtail”) or that the wheel is suspended on the rest of the frame structure via a rear swing arm (“fully”). A suspension of the saddle and/or the front wheel is also known. The present invention can be applied to all known configurations of the rear structure of a vehicle or bicycle, for example, single link, Horst link, VPP (virtual pivot point), flex rear structure, split pivot and others. Such systems are described, for example, in U.S. Pat. Nos. 8,733,774B2, 5,899,480A, 10,106,221B2, WO2020154800A1, and U.S. Pat. No. 7,828,314B2. It is now essential that, in contrast to this conventional frame structure, two further elements are now provided in accordance with the invention, which are additional to the frame and whose primary task is to absorb tensioning forces for the input and output traction means. These elements are the first and second support units. The first support unit and the second support unit are configured to rotate separately from or relative to each other, in particular about the transmission traction means pulley unit. Moreover, the first support unit and the second support unit are rotatably mounted on the frame. Further, it is preferred that the transmission traction means pulley unit is mounted exclusively via the first support unit and the second support unit. The rotatability of the support units relative to the frame or the exclusive mounting of the transmission traction means pulley unit via the first and second support units ensures that the tensioning forces of the traction means are actually absorbed by the support units in order to decouple the traction forces of the traction means completely without any reaction on the rear axle. This enables drive-independent behavior of the rear wheel suspension, for example to optimize antisquat. For example, the traction mechanism unit is thus mounted on the frame exclusively in the region of the input traction means pulley and the output traction means pulley. This region of the input traction means pulley and the output traction means pulley describes in particular that section of the respective support unit in which the respective traction means pulley is actually located. The respective region thus extends over the spatial dimensions of the traction means pulleys and ends with them. The two support units are thus mounted on the frame at their ends spaced from each other. At the respective opposite ends, in turn, the support units are rotatably connected to each other via the transmission traction means pulley unit. Altogether, therefore, the two support units form pivoting arms connected in the manner of a toggle lever, the bending point of which is located in the rotation axis of the transmission means pulley unit. In order to ensure the greatest possible movability of the traction mechanism unit and in particular of the input traction means pulley relative to the output traction means pulley even when the vehicle is in operation, the traction mechanism unit in the region of the transmission traction means pulley unit is thus not mounted directly on the frame but is in particular adjustable relative to it. The transmission traction means pulley unit is therefore configured to float freely relative to the frame. In particular, it is configured to be movable relative to the frame. The resulting flexibility facilitates assembly and brings further advantages in operation, which are explained in more detail below. This structure according to the invention allows the frame to absorb wheel contact forces occurring during operation of the vehicle, bypassing the first support unit and the second support unit. Wheel contact forces in this context refer to all vertically and/or horizontally acting forces that are introduced from the ground via at least one wheel into the vehicle and in particular the frame. This includes, for example, forces that counteract weight forces or rolling resistance forces that occur. In addition, this may also include load-bearing and/or damping forces as well as forces from the vehicle dynamics during travel and drive operation of the vehicle. The wheel contact forces are absorbed exclusively by the frame or act exclusively on it. They therefore do not act on the support units or the traction mechanism unit. The support units, or the traction mechanism unit, are bypassed by the frame when the force is absorbed. This means that the wheel contact forces would act in exactly the same way, particularly on the frame, if the traction mechanism unit were removed from the vehicle. The traction mechanism unit or its presence or absence on the vehicle does not influence the action of the forces.

Generally, the support units may be attached or mounted at any points on the frame of the vehicle. Preferably, the support units are at least indirectly mounted on, and rotatable relative to, the frame, for example via a connection to one or more shafts of the drive system or the rear or front wheel. In particular, the connection may comprise one or more roller bearings to enable the traction mechanism unit to be adjusted relative to the frame even when mounted. However, the rotation axes of the support units on the frame do not necessarily have to coincide with the drive axis or the front wheel axis or the rear wheel axis of the vehicle. The drive axis of the vehicle describes the rotation axis about which a shaft of the vehicle driven by pedals and/or a drive motor rotates. This may be, for example, the rotation axis of the pedal crankshaft and/or the rotation axis of an output shaft of a drive motor or drive unit. In particular, the drive axis is the rotation axis of a drive shaft of a drive unit to which drive energy resulting from a combination of human muscle strength and at least one drive motor is applied. According to a preferred embodiment, the first support unit is mounted on the frame such that it can rotate or pivot about the drive axis of the vehicle. The pivotability refers to a movability about this axis, although the movability does not have to be completely circumferential, but may also only apply to a certain angular range. The first support unit thus sits, for example, on the pedal crankshaft and/or on a drive shaft of a drive motor or drive motor unit. Additionally or alternatively, it is preferred that the second support unit is mounted on the frame such that is is rotatable about the rear wheel axis or the front wheel axis of the vehicle. The second support unit is mounted on the wheel that is to be driven via the traction mechanism unit. This wheel may be the front or rear wheel. It is particularly preferred if the traction mechanism unit is mounted on the frame exclusively via these mounting points. The traction mechanism unit is thus mounted on the frame exclusively via the rotatable mounting of the first support unit about the drive axis of the vehicle and via the rotatable mounting of the second support unit about the rear wheel axis or the front wheel axis. In particular, the traction mechanism unit is not connected to the frame at the connection point between the first support unit and the second support unit, at which the transmission traction means pulley unit is also arranged, but is configured to be free-floating or movable relative to the frame. The corresponding arrangement of the support units results in a particularly simple transmission of the drive energy from the pedals or a drive motor unit to the traction mechanism unit and from the latter to the driven wheel, be it the front or the rear wheel. In this context, it is essential that, due to this structure, the traction force of the traction means does not act on the axles of the front or rear wheel. This eliminates interaction between drive forces and suspension, which in turn enables an optimization of the antisquat behavior independently of the drive.

The drive energy can be transmitted particularly easily if, according to a preferred embodiment, the input traction means pulley is arranged coaxially to the drive axis of the vehicle and/or the output traction means pulley is arranged coaxially to the rear wheel axis or the front wheel axis of the vehicle. The input traction drive pulley thus rotates about the same rotation axis as a drive shaft of a drive unit, which may be driven in particular by a combination of human muscle strength and a drive motor. The output traction means pulley, on the other hand, rotates about the same rotation axis as the wheel driven by the overall traction mechanism unit. The traction mechanism unit thus transmits the drive energy from the drive shaft to the respective driven wheel, for example the rear wheel or the front wheel.

As already mentioned, the transmission axis implements the knee between the two support units, so to speak. In order to ensure the greatest possible scope for compensating for changes in distance between the input traction means pulley and the output traction means pulley via this knee, i.e., via the relative pivotability of the support units relative to one another about the transmission axis, it is particularly preferred that the transmission axis is arranged vertically above or below the drive axis and/or the rear wheel axis or the front wheel axis of the vehicle. When the transmission axis is arranged vertically above the ax(l)es mentioned, it is at the same time ensured that the traction mechanism unit is particularly far away from the ground, for example a roadway, and is therefore protected against collisions with obstacles.

On conventional vehicles with a suspended driven wheel, such as a front wheel or rear wheel, there is an effect called pedal kickback. This effect describes that every time the suspension compresses, the traction means automatically cause the drive shaft, and thus also the pedal crankshaft, for example, to rotate. This also causes the pedals to rotate, which, in addition to being perceived as unpleasant by the driver, also affects the compressing behavior. The occurrence of this effect can be avoided with the traction mechanism unit according to the invention, because the fact that the transmission traction means pulley unit is movable relative to the frame means that it can compensate for changes in distance between the drive axis and the rear wheel axis without changing the adjusting position of the traction means. Irrespective of this, this compensation is particularly successful if the traction mechanism unit is combined with a drive unit that already has a gearshift, so that there is no need for a gearshift on the driven wheel, for example on the rear wheel.

It is regularly advantageous for generic vehicles to be as narrow as possible, especially in the region of the front and rear wheels. This also applies to the traction mechanism unit according to the invention. According to a preferred embodiment of the invention, the second support unit is therefore arranged offset relative to the first support unit toward the center of the vehicle in the direction of the rear wheel axis or the front wheel axis. In particular, the output traction means pulley is also offset relative to the input traction means pulley toward the center of the vehicle in the direction of the rear wheel axis or the front wheel axis. The same also applies to the output traction means relative to the input traction means. In this way, the first support unit is offset further outwards from the center of the vehicle in the region where space is required anyway for a drive unit, for example comprising a drive motor, on the drive shaft, while the displacement of the second support unit toward the center of the vehicle in the region of the driven wheel ensures the desired narrow configuration. In this regard, the center of the vehicle refers to a virtual center plane running in the longitudinal direction of the vehicle as well as in the vertical direction, which has the same perpendicular distance to both outermost sides or outermost points of the vehicle.

Due to the distance of the traction means, for example the chain, to the rear wheel, which is typically imposed by the presence of a gearshift cassette on the rear wheel, the spokes of the rear wheels of conventional vehicles, for example bicycles, must be arranged asymmetrically. However, this then results in different loads on the spokes, which reduces their overall service life. It is therefore preferred that the rear wheel and/or the front wheel have a set of spokes symmetrical about a symmetry axis. The spokes are in this case arranged symmetrically on the rear wheel and/or the front wheel. The symmetry axis of the spokes therefore also corresponds to the symmetry axis of the rim and tire of the respective wheel. The symmetrical arrangement is made possible by the fact that, according to the invention, the second support unit and, in particular, the output traction means pulley are significantly closer to the symmetry axis of the wheel than is possible in a conventional arrangement with a cassette.

In one embodiment of the present invention, the rear wheel is connected to at least one rear wheel strut or rear wheel swing arm belonging to the frame. For example, the rear wheel is connected to the seat tube via the rear wheel strut. The rear wheel strut may now be connected to the rest of the frame, in particular the seat tube, such that it is rotatable about a strut bearing. The rotatability of the rear wheel strut about the strut bearing enables the rear wheel to be suspended relative to the frame or the seat tube. It is now advantageous if the rear wheel is suspended, in particular indirectly via the rear wheel strut, on the frame, for example the seat tube and/or the top tube or the down tube, via a damper. In order to prevent the rear wheel strut and the traction mechanism unit from getting in the way of each other and at the same time to enable a narrow structure at the rear wheel, it is preferred for the rear wheel strut coming from the rear wheel to be bent upward in vertical direction so that it extends over or spans the traction mechanism unit in the manner of an arc, in particular in vertical direction above the traction mechanism unit. The curved rear wheel strut is thus preferably arranged in an upward curve above the traction mechanism unit. This provides an installation space in vertical direction below this arc which can be used to accommodate the traction mechanism unit, in particular the transmission means pulley unit. This arrangement makes it possible, on the one hand, to obtain a comparatively large overall clearance from the ground in vertical upward direction, which is particularly advantageous when riding off-road. On the other hand, a large suspension travel can be provided without components of the traction mechanism unit hitting parts of the frame. The strut bearing, at which the rear wheel strut is pivotably connected to the rest of the frame, is preferably arranged offset from the frame-side rotation axis, for example the drive axis, of the first support unit. Particularly preferably, the strut bearing is arranged vertically above the frame-side rotation axis, for example the drive axis or the crankshaft, of the first support unit. The corresponding configuration meets all the requirements for a modern frame configuration of a generic vehicle.

As already indicated above, it is advantageous if the traction mechanism unit is configured as a separate and self-contained module which, for example, can already be provided with the pretensioning of the traction means at the factory and is then merely mounted on the vehicle by the end user or manufacturer as a cohesive overall unit, in particular in one step. Particularly preferably, this module also comprises the braking device or at least parts thereof. According to this preferred embodiment, the traction mechanism unit thus has a modular configuration as a coherent structural unit that can be removed from or mounted on the vehicle together with the brake disc and/or the brake caliper. It will be understood that suitable connection points may then be provided for brake actuation devices, such as Bowden cables or hydraulically actuated means. In particular, the structural unit may be configured such that the input traction means and/or the output traction means can be pretensioned ready for use independently of the vehicle and thus in particular when dismounted from the vehicle. This is again made possible by the fact that the support units of the traction mechanism unit themselves absorb the tensioning forces of the traction means without requiring the frame of the vehicle for this purpose. To achieve this as practicably as possible, the traction mechanism unit may have connection points, in particular a connection point for connecting the input traction means pulley to the drive shaft of the vehicle and a connection point for connecting the output traction means pulley to the driven wheel, for example the rear wheel or the front wheel. To mount the modular traction mechanism unit, all that is then required is to connect these connection points to the drive shaft and the driven wheel or its hub body, in particular in a co-rotating manner, more particularly co-rotating in at least one direction of rotation. These connection points may be connection devices known per se from the prior art for connecting a traction means roller to an axis or a unit rotating about an axis, such as a coupling device, in particular a form-fitting coupling. The rotatability of the two support units relative to each other about the transmission traction means pulley unit makes this assembly particularly simple, since the same modular traction mechanism unit can compensate for different distances between the drive shaft and the driven wheel by rotating the support units. This leaves considerably more room for manufacturing tolerances, for example.

Generally, the exact implementation of the connection point for connecting the output traction means pulley to the driven wheel may vary. For example, a frictional or non-positive connection could be used here. It is particularly preferred if the output traction means pulley is connected to a rear wheel hub body or a front wheel hub body via an axially releasable form-fitting connection acting in the direction of rotation, which is configured in particular as a Hirth toothing. The axial direction refers in particular to the direction of the respective wheel axle, for example the rear wheel axis or the front wheel axis. The axial releasability of the form-fitting connection allows easy mounting via a quick-release axle already commonly used on the driven wheel. The form fit in the direction of rotation in turn ensures safe and efficient transmission of the drive energy from the output traction means pulley to the rear wheel hub body and thus to the rear wheel or to the front wheel hub body and thus to the front wheel.

The traction mechanism unit according to the present invention can also be used to simplify the change of the driven wheel. For this purpose, the traction mechanism unit may in particular remain on the frame of the vehicle when the driven wheel has been removed from the frame. For this purpose, it is preferred that the rear wheel hub body and/or the front wheel hub body is configured to be dismountable from the output traction means pulley via the form fit in such a way that the rear wheel hub body and/or the front wheel hub body can be dismounted from the vehicle together with the rear wheel or the front wheel, respectively, while the traction mechanism unit with the output traction means pulley, and in particular the brake disc and/or the brake caliper, remains on the frame. For this purpose, the traction mechanism unit is mounted on the frame of the vehicle, for example on a rear wheel strut, via a bearing sleeve. In particular, the bearing sleeve is fixed to the frame and can also accommodate the rear wheel axis body. The bearing sleeve also remains on the frame when the driven wheel is dismounted. To change the driven wheel, an operator therefore only has to pull the quick-release axle out of the hub body and release the form-fitting connection between the hub body and the output traction means pulley in axial direction of the rear wheel axis or the front wheel axis. The driven wheel can then be removed from the frame while the traction mechanism unit remains attached to it. In particular, the traction mechanism unit is still mounted on the rear wheel strut via the bearing sleeve. The operator therefore does not have to perform any work at all on the traction mechanism unit to change the driven wheel. In particular, the operator will not have to release the pretension of the traction means or remove the traction means from their traction means pulleys. Changing the driven wheel is therefore much easier and faster than with conventional vehicles.

The object mentioned at the beginning is further achieved with the methods according to the invention, including a method for assembling a vehicle, in particular a vehicle according to the preceding discussion. Furthermore, the object is achieved with a method for avoiding pedal kickback in a vehicle, in particular a vehicle according to the foregoing discussion, and/or a vehicle assembled according to the method for assembling a vehicle. All the features, effects and advantages explained above for the traction mechanism unit and/or the vehicle also apply mutatis mutandis to the methods according to the invention and vice versa. The same applies to the methods according to the invention with respect to each other. Merely to avoid repetitions, reference is made to the respective other explanations.

As already mentioned, the above-mentioned object is achieved with a method for assembling a vehicle, the vehicle having a modular traction mechanism unit, in particular a traction mechanism unit according to the preceding discussion, with a first support unit with an input traction means and a second support unit with an output traction means, the two support units being connected to one another in an articulated manner and being pivotable relative to one another about a common transmission axis, comprising the steps of: pretensioning the input traction means and the output traction means in the traction mechanism unit, wherein the pretensioning forces of the input traction means and the output traction means are absorbed exclusively by the support units, installing the modular traction mechanism unit on the vehicle, and compensating for tolerances by pivoting the support units about the transmission axis. Since the pretensioning of the traction means can already be set at the factory, end users will not have to concern themselves with pretensioning at all. Therefore, no special tools are required for the assembly of the vehicle to adjust the high tensions that are necessary, for example, when using belts as the traction means. Compensating for different distances between the mounting points of the traction mechanism unit by pivoting the support units relative to each other further simplifies assembly and enables the same traction mechanism unit to be used for a wide range of different vehicle or vehicle frame configurations. In addition, the traction mechanism unit may at the same time also carry a braking device or at least parts thereof, such as a brake disc and/or a brake caliper, and/or further elements, in particular functional elements, such as integrated cable connections, one or more sensors, etc. These can then be preassembled together with the rest of the traction mechanism unit and installed simultaneously as a coherent module in a vehicle of the type according to the invention.

The above-mentioned object is further achieved with a method for avoiding pedal kickback in a vehicle, wherein the vehicle, in particular configured according to the invention, has a frame, a suspended rear wheel or a suspended front wheel and a modular traction mechanism unit, in particular a traction mechanism unit according to the preceding discussion, with a first support unit with an input traction means and a second support unit with an output traction means, the two support units being connected to one another in an articulated manner and being pivotable relative to one another about a common transmission axis, and the traction mechanism unit transmitting drive energy from an input traction means pulley to an output traction means pulley, comprising the steps of: compressing the suspension of the rear wheel or the front wheel and compensating for a change in distance between the input traction means pulley and the output traction means pulley caused by the compression motion by pivoting the support units about the transmission axis and simultaneously moving the support units, such that the transmission axis moves relative to the frame. By compensating for the change in distance according to the invention, pedal kickback is avoided, as explained above, taking into account the traction means pulley diameters, resulting in a more comfortable riding experience for a rider. This also makes it possible to set an optimum antisquat behavior for the chassis.

A further aspect of the invention also lies in a method for transmitting a drive torque of a single-track or multi-track vehicle, in particular a vehicle configured according to the invention, via a traction mechanism unit, in particular a traction mechanism unit according to the preceding discussion describing the invention. Essential steps of the method now consist in absorbing tensioning forces of a traction mechanism unit in isolation from a frame, followed by introducing torque forces via an input traction means pulley into the traction mechanism unit. These introduced torque forces are then transmitted, in isolation from the frame, to an output traction means pulley via at least two traction means arranged in series with one another, i.e., arranged one after the other in a direction of force transmission. A final step consists in diverting the torque forces via the output traction means pulley to drive the front or rear wheel. This method according to the invention may additionally comprise relative adjustment of a first and a second support unit, and reference is made to the preceding discussion regarding the structure and function of these support units. Overall, this method allows decoupling of the traction means' forces toward the rear axle, which in the final result allows for antisquat optimization independent of the intersection point of the traction means line with the antisquat line. In other words, a change in relative position between a front or rear axle and a drive axis, for example a pedaling axis, is compensated for by a change in relative position of the first and second support elements of the traction mechanism unit without changing distances between the traction means pulleys of the respective support unit. Instead, to compensate for the change in distance, the relative position of the two support units to each other is adjusted. This is done without affecting the tension of the traction means.

Finally, another aspect of the invention relates to a method for eliminating interaction between a drivetrain with a traction mechanism unit and a suspension/damping device in a single- or multi-track vehicle, in particular a bicycle, pedelec, e-bike or bicycle with an auxiliary drive, in particular a vehicle according to the invention. In terms of basic structure, a vehicle suitable for the method according to the invention comprises a front wheel and at least one rear wheel. These are both mounted on a frame, the frame for this method according to the invention being of multi-part configuration and having a main frame and a wheel strut pivotably mounted thereon. The front wheel is rotatably mounted to this frame about a front wheel axis and the rear wheel is rotatably mounted about a rear wheel axis, the front wheel or the rear wheel being mounted to the main frame via the wheel strut. One of the two wheels can thus be pivoted relative to the main frame. This is used in a manner known per se, for example to effect vehicle damping. For this purpose, it is known to provide a suitable suspension/damping device between the wheel strut and the main frame. The suspension/damping device designates a device, which is also known per se in the prior art, for example, whose function lies in the suspension and damping of adjusting movements between the main frame and the wheel strut pivotably arranged thereon. Furthermore, for the method according to the invention, a traction mechanism unit, in particular according to the invention, is provided with at least two traction means, in particular belts, arranged in series with one another. Preferably, a traction mechanism unit according to the invention is used for this purpose. The traction mechanism unit is in drive connection between a drive axis and a rotation axis of the front wheel or the rear wheel. With the aid of the traction mechanism unit, a drive torque is thus transmitted from the input rotation axis, for example a pedaling axis and/or motor axis, to the respective driven wheel. The method according to the invention may now comprise damped/suspended pivoting of the wheel strut and the wheel mounted thereon relative to the main frame using the suspension/damping device, for example when riding over or through an obstacle. Separate to this, for example, an independent transmission of a drive torque is provided. This means that a change in the relative position of the driven wheel/wheel strut, which is suspended/damped relative to the main frame, has no effect on the drive torque currently transmitted via the traction mechanism unit. This may in particular comprise compensating for changes in distance between the drive axis and the rotation axis by a rotation of a first support unit of an input traction means relative to a second support unit of an output traction means of the traction mechanism unit. Via the rotation or the associated angular changes in the angular position of the two support units relative to each other, a compensation is thus provided for the changes in distance between the drive axis and the rotation axis of the driven wheel that occur as a result of the compression/decompression process, without this having any effect on the traction means or on the angular position or relative rotational position between the wheel and pedaling axes themselves and without influencing the rotational position of the drive axis and the driven wheel. This eliminates feedback effects on the torque-transmitting traction means caused by the change in relative position between the drive axis and the rotation axis during the compression/decompression process. In other words, the drive torques are transmitted independently of tensioning forces of the traction means, in particular without causing feedback effects on the pivoting of the wheel strut and the wheel mounted thereon relative to the main frame. The rotational position of the driven wheel axle and the input rotation axis therefore do not change their relative position to the ground during the compression/decompression process, but they do relative to the main frame.

The invention will be explained in more detail below by reference to the embodiment examples shown in the figures. In the schematic figures:

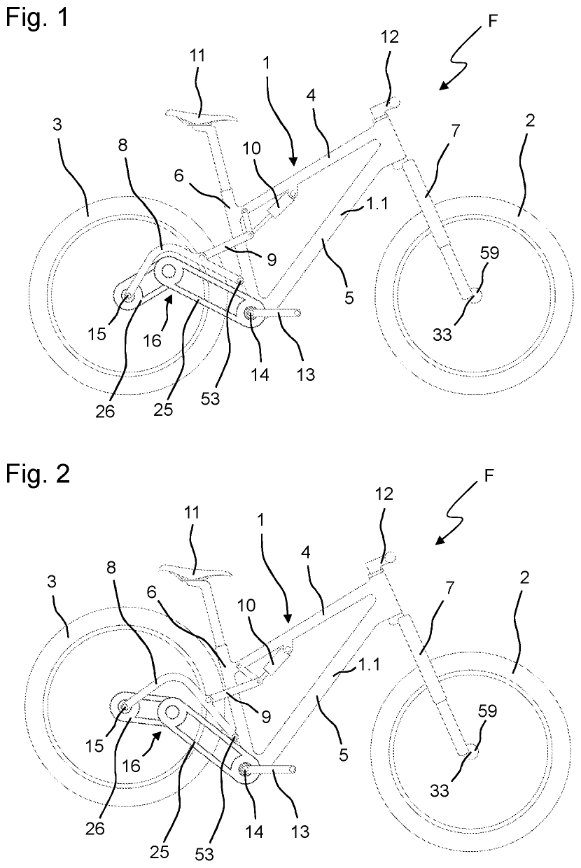

FIG. 1: is a side view of a vehicle;

FIG. 2: is a side view of a vehicle with compressed rear wheel suspension;

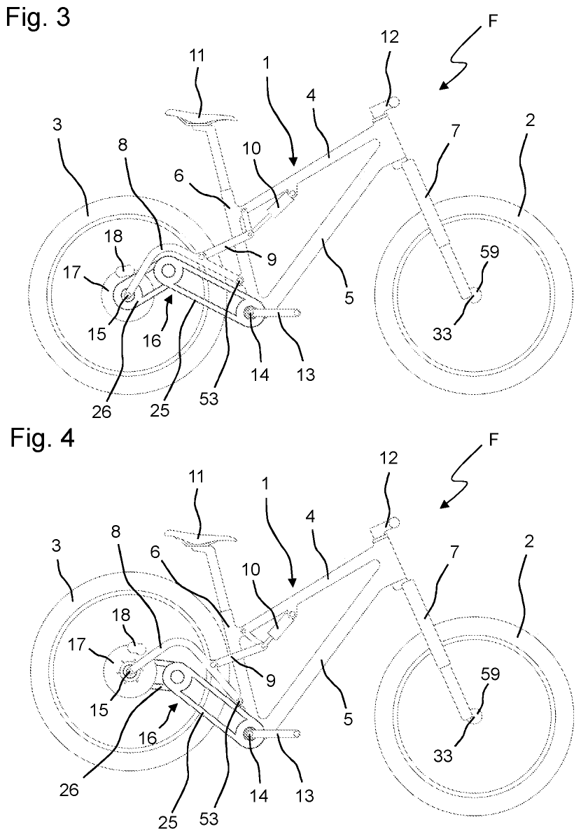

FIG. 3: is a view according to FIG. 1 with a braking device;

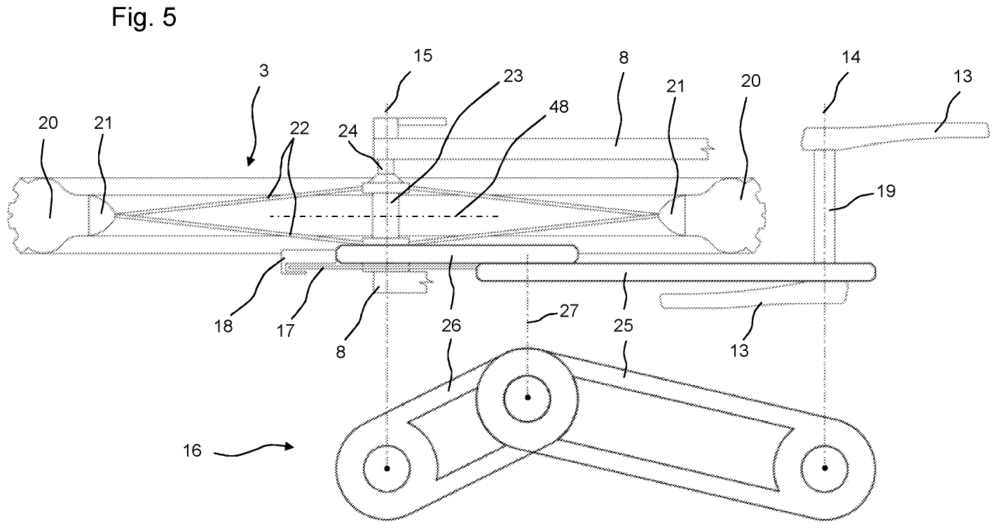

FIG. 4: is a view according to FIG. 2 with a braking device;

FIG. 5: is an overview of the arrangement of a traction mechanism unit from the crankshaft to the rear wheel;

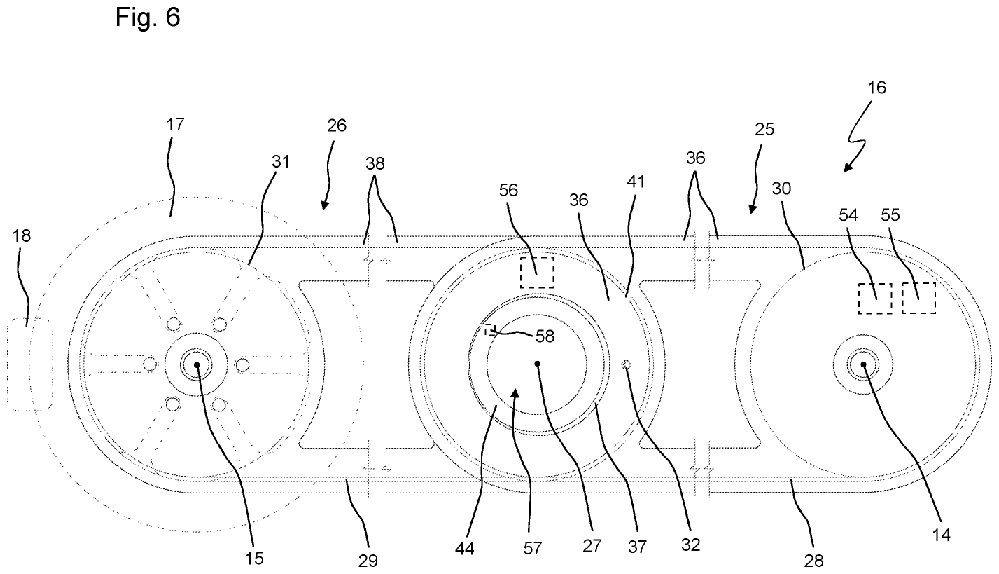

FIG. 6: is a side view of the traction mechanism unit;

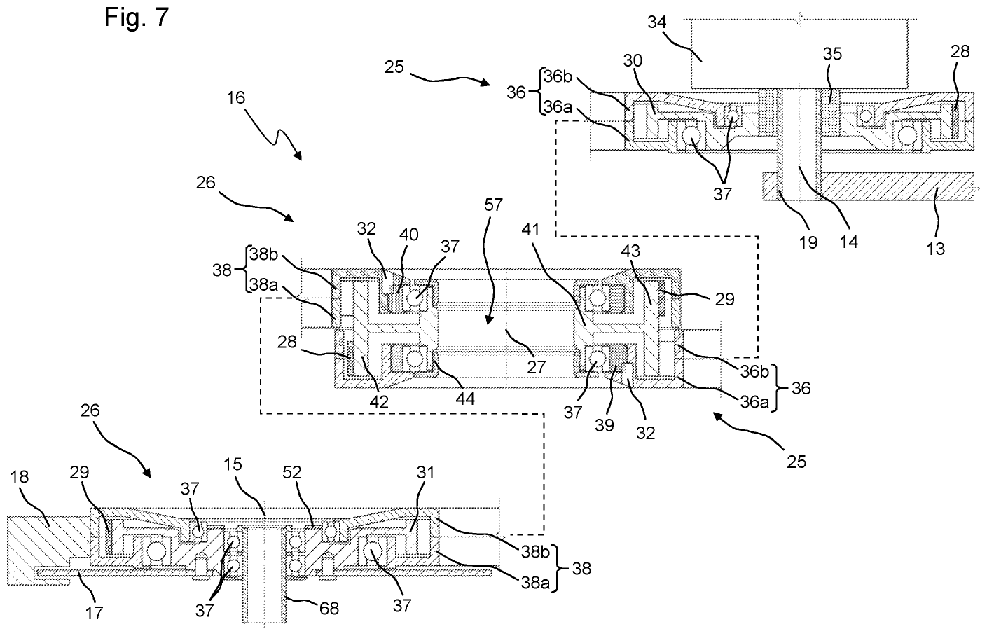

FIG. 7: are cross-sectional views from above of the traction mechanism unit;

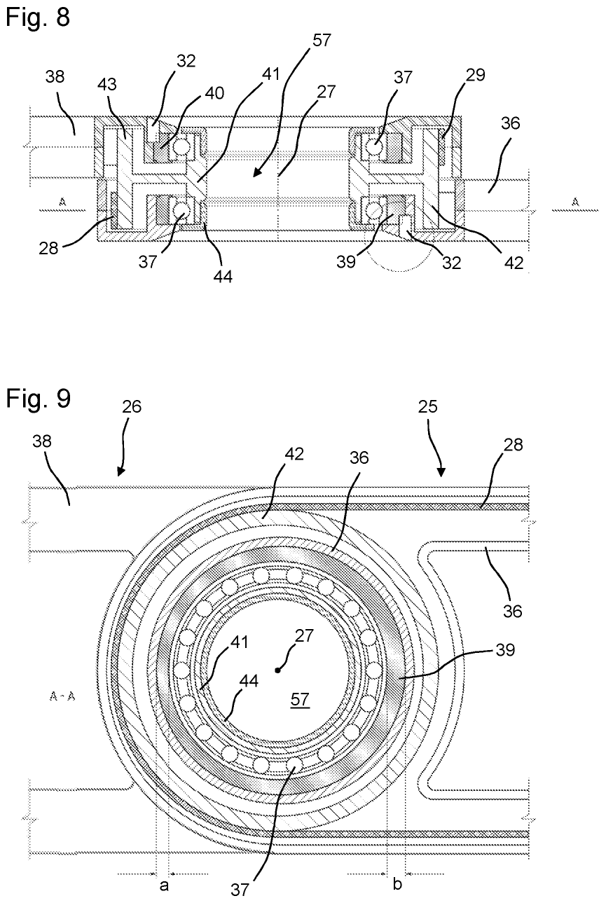

FIG. 8: is a cross-sectional view from above of the transmission traction means pulley unit;

FIG. 9: is a cross-sectional side view of the transmission traction means pulley unit according to sectional plane A of FIG. 8;

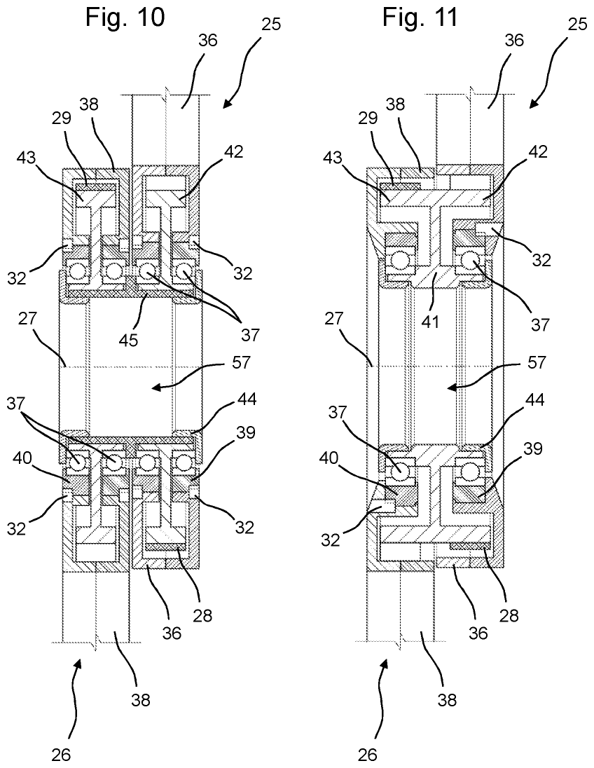

FIG. 10: is a cross-sectional view from above of a first embodiment of the transmission traction means pulley unit;

FIG. 11: is a cross-sectional view from above of a second embodiment of the transmission traction means pulley unit;

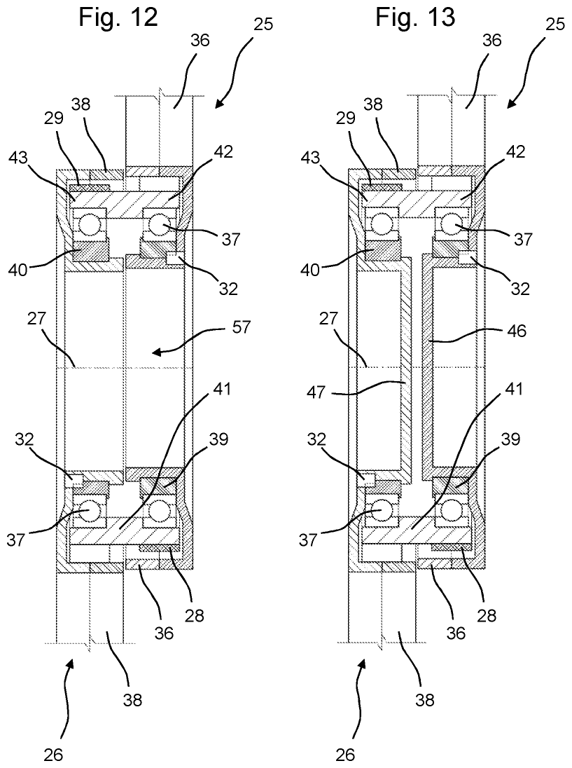

FIG. 12: is a cross-sectional view from above of a third embodiment of the transmission traction means pulley unit;

FIG. 13: is a cross-sectional view from above of a fourth embodiment of the transmission traction means pulley unit;

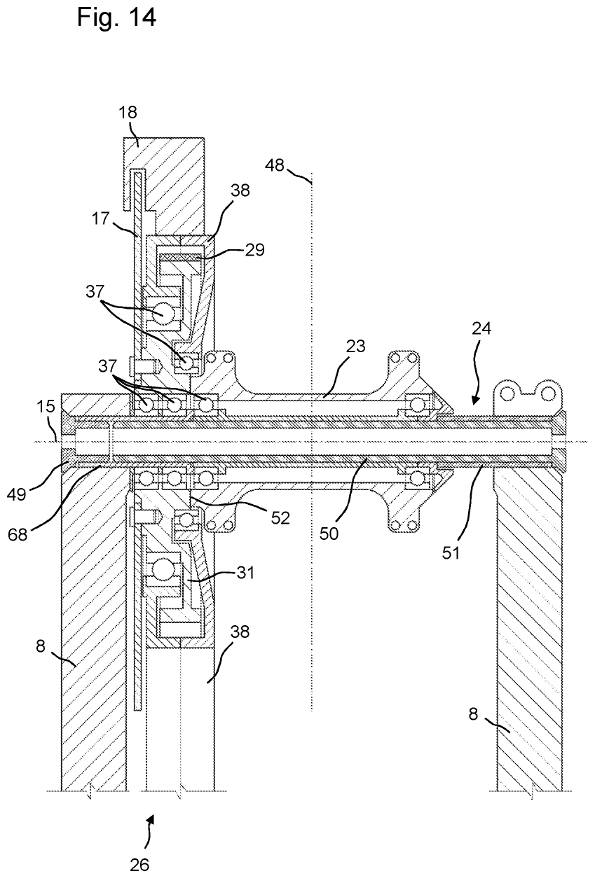

FIG. 14: is a cross-sectional view from above of the second support unit and the rear wheel hub with the rear wheel mounted;

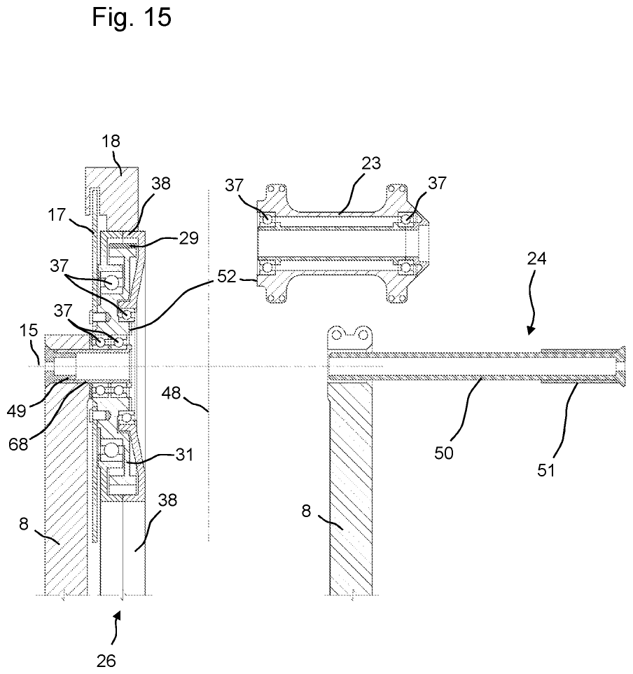

FIG. 15: is a cross-sectional view from above of the second support unit and the rear wheel hub with the rear wheel dismounted;

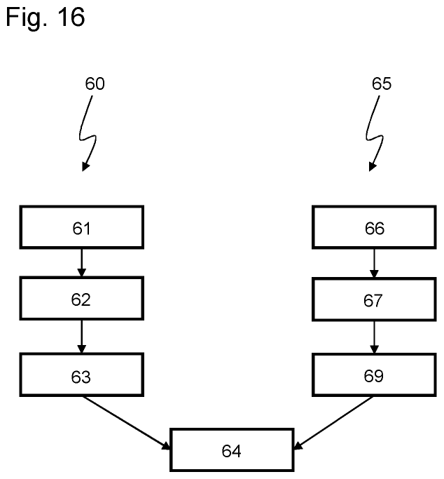

FIG. 16: is a flow chart of the method;

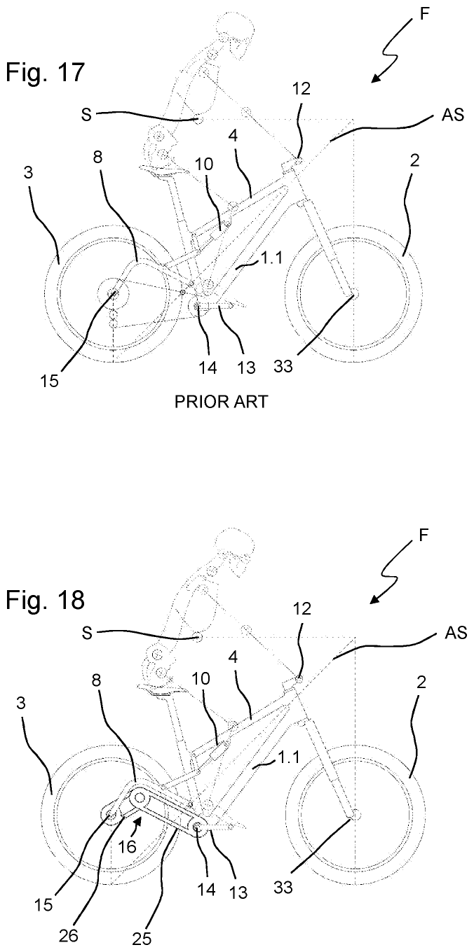

FIG. 17: is a side view of a prior art vehicle with conventional chain drive and antisquat line; and

FIG. 18: is a side view of the vehicle of FIG. 1 with antisquat line.

Like parts or functionally like parts are designated by like reference numerals in the figures. Recurring parts are not designated separately in each figure.

FIGS. 1 to 4 each show a vehicle F using the example of a bicycle, in particular an e-bike. For example, the bicycle has a frame 1 that can be supported by a front wheel 2 and a rear wheel 3. For example, the frame 1 may comprise a top tube 4, a down tube 5, a seat tube 6, a front fork 7, a rear wheel strut 8 or rear wheel swing arm, and a seat strut 9. The front fork 7 may be connected to a front wheel hub body 59, via which the front wheel 2 may be mounted to the frame 1. The front wheel 2 may be mounted for rotation about a front wheel axis 33. For steering the vehicle F, which is configured as a bicycle, the front fork 7 may be connected to a handlebar 12 in a co-rotating manner. A saddle 11 may be arranged on the saddle tube 6. The rear wheel strut 8 may, for example, be rotatably connected to the remaining frame parts, for example the seat tube 6, via a strut bearing 53. The frame 1 as a whole thus comprises a main frame 1.1, in the present case for example including the top tube 4, the down tube 5, the front fork 7 and the seat tube 6, and a rear wheel strut 8 which can be pivoted about a horizontal pivot axis relative to this main frame 1.1 for suspension/damping purposes. The front wheel 2 is mounted on the main frame 1.1 and the rear wheel 3 is mounted on the rear wheel strut 8, although the opposite may be the case as well. Via this rotatability or pivotability, the rear wheel 3 may thus be suspended on the frame 1, for example via a seat strut 9 connected to the rear wheel strut 8, which in turn may be connected to the top tube 4 via a damper 10, for example. The actual configuration of the suspension/damping device may vary. FIGS. 1 and 3 show the bicycle in a rest position. FIGS. 2 and 4 in turn show the bicycle with the suspension of the rear wheel 3 compressed to the maximum. The rear wheel strut 8 supports the rear wheel 3 rotatably about a rear wheel axis 15, for example. In order to enable a rider of the vehicle F or of the bicycle, respectively, to introduce drive energy from human muscle strength into the drive train of the vehicle F, the latter may have a pedal 13, in particular one pedal 13 per side. The frame 1 described is basically known in the prior art, so that the structure and interaction of the individual frame parts are known to the skilled person.

To transmit drive energy to the rear wheel 3, the vehicle F may comprise a traction mechanism unit 16 that receives drive energy from a drive shaft 35 rotating about the drive axis 14 (see FIG. 7) and transmits it to the rear wheel 3. In the embodiment examples shown in FIGS. 1 to 4, the rear wheel 3 is the driven wheel of the vehicle F. However, the front wheel 2 might just as well be the driven wheel of the vehicle F. In this case, the traction mechanism unit 16 would transmit the drive energy from the drive shaft 35 rotating around the drive axis 14 (see FIG. 7) to the front wheel 2. Even though such embodiments are not shown in the figures, they are nevertheless encompassed by the invention.

The traction mechanism unit 16 may comprise a first support unit 25 and a second support unit 26. The first support unit 25 may, for example, be mounted on the frame 1 such that it is rotatable about the drive axis 14. The second support unit 26, on the other hand, may be mounted on the frame 1, for example the rear wheel strut 8, such that it is rotatable about the rear wheel axis 15. The support units 25, 26 may be connected to each other in an articulated manner between the drive axis 14 and the rear wheel axis 15 such that they can be pivoted relative to each other, for example. This pivotability is used in particular when the distance between the drive axis 14 and the rear wheel axis 15 changes, as is the case, for example, when the suspension of the rear wheel 3 is compressed. As can be seen from a comparison of FIGS. 1 and 2 and FIGS. 3 and 4, respectively, a corresponding change in distance between the drive axis 14 and the rear wheel axis 15 can be compensated for by pivoting the first support unit 25 relative to the second support unit 26 of the traction mechanism unit 16. Due to the special structure of the traction mechanism unit 16, which will be explained in more detail below, pedal kickback is prevented in this case or even a desired positive or negative pedal kickback is set. This makes it possible to completely eliminate feedback effects on the traction mechanism unit caused by the compression and decompression process in conventional systems.

In FIGS. 1 to 4, the arrangement of the traction mechanism unit 16 is shown such that the articulated connection of the support units 25, 26, i.e., the transmission axis 27, is arranged vertically above the mounting of the first support unit 25 about the drive axis 14 and/or the mounting of the second support unit 26 about the rear wheel axis 15. Alternatively, however, it could just as well be that the traction mechanism unit 16 is configured and arranged such that the articulated connection of the support units 25, 26 is arranged vertically below the mounting of the first support unit 25 about the drive axis 14 and/or the mounting of the second support unit 26 about the rear axis 15. As also shown in FIGS. 1 to 4, the rear wheel strut 8 may be curved, in particular curved such that it has a vertex projecting upward, in particular as seen from the rear wheel axis 15. The rear wheel strut 8 may thus be configured to run around or bypass the traction mechanism unit 16 and, in particular, the articulated connection between the first support unit 25 and the second support unit 26 in a vertically upward direction. In other words, the rear wheel strut 8 may be configured to spatially circumvent the traction mechanism unit 16 in order to leave it the installation space in the region between the drive axis 14 and the rear wheel axis 15.

The difference between the embodiments of FIGS. 1 and 2 and FIGS. 3 and 4, respectively, is that FIGS. 3 and 4 show a vehicle F equipped with a braking device comprising a brake disc 17 and a brake caliper 18. The braking device may, for example, be arranged on the traction mechanism unit 16, for example on the second support unit 26. FIG. 3 shows an example in which the braking device can be arranged on the traction mechanism unit 16 between the traction mechanism unit 16 and the rear wheel 3. In other words, in this example, the braking device on the traction mechanism unit 16 is arranged on the side of the traction mechanism unit 16 facing the rear wheel 3. FIG. 4, on the other hand, shows an alternative embodiment in which the braking device on the traction mechanism unit 16 is arranged on the side of the traction mechanism unit 16 facing away from the rear wheel 3. In other words, in this embodiment, the traction mechanism unit 16 is arranged between the braking device and the rear wheel 3.

The arrangement according to the embodiment of FIG. 4 is shown in more detail in FIG. 5. In particular, the upper part of FIG. 5 shows a horizontal cross-section through the rear wheel 3 rotating about the rear wheel axis 15, parts of the frame 1 and the crankshaft 19 driven by the pedals 13 rotating about the drive axis 14. For better understanding and orientation, a side view of the traction mechanism unit 16 is again shown below, such that the arrangement of the rear wheel axis 15, the drive axis 14 and the transmission axis 27, about which the first support unit 25 and the second support unit 26 can be rotated relative to one another, corresponds between the upper and lower parts of FIG. 5. FIG. 5 also shows the structure of the rear wheel 3. The rear wheel may comprise a tire 20 and a rim 21. The rim 21 may be connected to a rear wheel hub body 23 via spokes 22. In turn, the rear wheel hub body 23 may be mounted on a rear wheel axle body 24 supported, for example, by two rear wheel struts 8 such that it can rotate about the rear wheel axis 15. The rear wheel hub body 23 is driven by the traction mechanism unit 16, as will be explained in more detail below. In order to achieve the narrowest possible structure, particularly at the rear wheel 3, the second support unit 26 may be offset from the first support unit 25 along the rear wheel axis 15 toward the center of the vehicle. Toward the center of the vehicle can mean, for example, in the direction of the rear wheel 3 or in the direction of the symmetry axis 48, which will be explained in more detail below. Due to the fact that the second support unit 26 and thus also the force transmission to the rear wheel hub body 23 is particularly close to the rear wheel 3, the rear wheel 3 may have a symmetrical set of spokes 22. In particular, the spokes 22, the rim 21 and the tire 20 may share a common symmetry axis 48. Due to the symmetrical arrangement of the spokes 22, they are evenly loaded and thus have an increased service life.

The general structure of the traction mechanism unit 16 is shown in FIG. 6. The traction mechanism unit 16 may comprise a first support unit 25 and a second support unit 26. The first support unit 25 may in this case be formed by a first housing 36, for example. The second support unit 26 may be formed by a second housing 38, for example. The two support units 25, 26 or housings 36, 38 may be connected to each other in an articulated manner such that they may be configured to pivot relative to each other about a common transmission axis 27. The first housing 36 may surround or enclose an input traction means pulley 30 rotatable about the drive axis 14 and at least partially surround or enclose a transmission traction means pulley unit 41. An input traction means 28, such as a toothed belt, may be arranged in operative connection with the input traction means pulley 30 and the transmission traction means pulley unit 41, such that the rotation of the input traction means pulley 30 is transmitted to the transmission traction means pulley unit 41. The second housing 38 may surround or enclose an output traction means pulley 31 rotatable about the rear wheel axis 15 and also at least partially surround or enclose the transmission traction means pulley unit 41. An output traction means 29, for example also a toothed belt, may be arranged in operative connection with the output traction means pulley 31 and the transmission traction means pulley unit 41, such that the rotation of the transmission traction means pulley unit 41 is transmitted to the output traction means pulley 31. As will be explained in more detail below, the input traction means pulley 30 may be driven by an input shaft 35 (see FIG. 7) of the vehicle F, while the output traction means pulley 31 may drive the rear wheel hub body 23 and thus the rear wheel 3. Overall, the traction mechanism unit 16 may therefore be configured to transmit the drive energy from the drive shaft 35 (see FIG. 7) to the rear wheel 3.

What is important is that the housings 36, 38 may be configured to accommodate the tensioning forces of the input traction means 28 and the output traction means 29. The tensioning forces of the traction means 28, 29 are thus introduced directly into the housings 36, 38, which is why the traction means 28, 29 can be pretensioned before the traction mechanism unit 16 is mounted on the frame 1 of the vehicle F. The traction mechanism unit 16 and in particular the first support unit 25 and the second support unit 26 or the first housing 36 and the second housing 38 can be configured such that no tensioning forces of the traction means 28, 29 are introduced into or transmitted to the frame 1. In order to pretension the traction means 28, 29, the traction mechanism unit 16 may have traction means tensioners 39, 40 (see FIG. 7), which are accessible from the outside for insertion of a corresponding tool for adjusting the pretension via pretensioning accesses 32 extending through the respective housing 36, 38. The traction means tensioners 39, 40 may be, for example, the eccentric traction means tensioners described in more detail below.

FIG. 6 also shows other elements that enable various functionalities of the traction mechanism unit 16. For example, a speed sensor 54 may be provided to determine the travel speed of the vehicle F. This sensor may be arranged on the input traction means pulley 30, for example, as in the embodiment example shown. However, the speed sensor 54 might just as well be located on the transmission traction means pulley unit 41 or the output traction means pulley 31. In addition, the traction mechanism unit 16 may include an electric generator 55, such as in the manner of a dynamo. In the embodiment example shown, this generator is also arranged on the input traction means pulley 30, but might just as well be arranged on the transmission traction means pulley unit 41 or the output traction means pulley 31. Finally, a suspension travel sensor 56 may be provided which, for example, concludes a suspension travel of the suspension of the rear wheel 3 based on the pivoting of the support units 25, 26 or the housings 36, 38 relative to one another about the transmission axis 27. The speed sensor 54 and/or the suspension travel sensor 56 may be connected to a control device (not shown) of the vehicle F in order to provide it with the measurement data. The traction mechanism unit 16 may have, in particular around the transmission axis 27, a through opening 57 which may completely extend through the traction mechanism unit 16 and in particular the transmission traction means pulley unit 41 and in particular may also be open to the outside. Further, an illumination device 58, for example comprising one or more LEDs, may be arranged in the region of this through opening 57. The illumination device 58 is in particular configured to illuminate the through openings 57 and/or an inner housing 44 arranged at least partially within the through opening 57.

FIG. 7 shows the structure of the traction mechanism unit 16 in detail. In particular, FIG. 7 shows a horizontal cross-section through the traction mechanism unit 16. As illustrated in FIG. 7, the first support unit 25 and the second support unit 26 are arranged at an angle of 180° to each other about the transmission axis 27, as already shown in FIG. 6. In other words, the knee formed between the support units 25, 26 by their rotatability about the transmission axis 27 is fully stretched. In order not to make the illustration too small-sized, the individual parts of the traction mechanism unit 16 are shown laterally offset from each other. In fact, as indicated by the dashed lines, the illustrated regions of the traction mechanism unit 16 are arranged one behind the other, or side by side.

The part of the traction mechanism unit 16 shown at the upper right of FIG. 7 shows the part of the first support unit 25 mounted for rotation about the drive axis 14. This part may include the input traction means pulley 30, which is driven by the drive shaft 35. The drive shaft 35, in turn, may be the output of a drive unit 34, which may comprise, for example, at least one drive motor (not shown), such as an electric motor. In particular, the drive unit 34 may be configured to output, via rotation of the drive shaft 35, a combination of the drive power applied by the rider of the vehicle F through human muscle strength via the pedals 13 and the crankshaft 19 and the drive power of the drive motor(s). Moreover, the drive unit 34 preferably already comprises a gear transmission ratio mechanism assuming the function of a gearshift, so that a gearshift is no longer necessary on the vehicle F outside the drive unit 34. The drive shaft 35 may be connected to the input traction means pulley 30 in a co-rotating manner, such that it is driven by the drive shaft 35. The input traction means pulley 30 is surrounded by a non-co-rotating first housing 36, on which the input traction means pulley 30 may be mounted via rotary bearings 37, for example roller bearings or ball bearings, in particular grooved ball bearings. For example, the housing 36 may consist of two housing halves 36a, 36b made of plastic, for example. The input traction means pulley 30 may be provided with an input traction means 28, which transmits the rotational motion of the input traction means pulley 30 to the transmission traction means pulley unit 41 shown in the center of FIG. 7.

The transmission traction means pulley unit 41 is shown in the middle illustration according to FIG. 7. It may be partially surrounded or enclosed by the first housing 36, which forms the first support unit 25, and partially surrounded or enclosed by the second housing 38, which forms the second support unit 26. The transmission traction means pulley unit 41 may comprise an input-side traction means pulley 42 operatively connected to the input traction means 28 coming from the input traction means pulley 30. In addition, the transmission traction means pulley unit 41 may comprise an output-side traction means pulley 43 operatively connected to the output traction means 29. In the embodiment example shown, the transmission traction means pulley unit 41 is configured as one integral component. In other words, the input-side traction means pulley 42 and the output-side traction means pulley 43 may be formed together as one integral piece. The transmission traction means pulley unit 41 may be supported relative to the non-co-rotating or stationary housings 36, 38 via rotary bearings 37. A through opening 57 may be arranged in the center of the transmission traction means pulley unit 41, particularly around the transmission axis 27, which completely extends through the traction mechanism unit 16. When viewed in the radial direction from the transmission axis 27, the through opening 57 may be bounded outwardly in part by the transmission traction means pulley unit 41 and in part by an additional inner housing 44 which may be configured to rotate with the transmission traction means pulley unit 41. Overall, therefore, the transmission traction means pulley unit 41 can transmit the drive power coming from the input traction means pulley 30 to the output traction means 29.

In turn, the output traction means 29 can transmit the rotational motion of the transmission traction means pulley unit 41 to the output traction means pulley 31 shown at the lower left of FIG. 7. The illustration at the lower left of FIG. 7 thus shows that part of the second support unit 26 which may be arranged on a bearing sleeve 68 for rotation about the rear wheel axis 15. In particular, the traction mechanism unit 16 may here comprise the output traction means pulley 31, which may be mounted for rotation about the rear wheel axis 15. For this purpose, the output traction means pulley 31 may be supported relative to the bearing sleeve 68 via rotary bearings 37. The output traction means pulley 31 may also be supported relative to the second housing 38, which is fixed to the frame and does not rotate with it, via rotary bearings 37. The second housing 38 may likewise consist of two housing halves 38a, 38b. Moreover, the brake disc 17 may be mounted on the output traction means pulley 31 in a co-rotating manner, for example via of a screw connection. The brake caliper 18, on the other hand, may be arranged on and connected to the second housing 38. The output traction means 29 can be used to apply the drive power coming from the drive unit 34 to the output traction means pulley 31. The output traction means pulley 31 can pass this drive power on to the rear wheel hub body 23, for example, via a form-fitting connection 52, for example, a Hirth toothing (see, for example, FIGS. 14 and 15).

FIG. 8 shows the cross-section according to the middle illustration in FIG. 7 slightly enlarged. In addition to the elements already described, this view according to FIG. 8 shows a first traction means tensioner 39, which may be provided for pretensioning the input traction means 28. In addition, a second traction means tensioner 40 may be provided, which may be provided for pretensioning the output traction means 29. The traction means tensioners 39, 40 are, for example, eccentric traction means tensioners. Both traction means tensioners 39, 40 are preferably accessible from the outside for a tensioning tool through a pretensioning access 32 (see the circled region in FIG. 8).

FIG. 9 shows a vertical cross-section through the traction mechanism unit 16 in the region of the transmission traction means pulley unit 41. The sectional plane extends through the input-side traction means pulley 42 according to the sectional plane A indicated in FIG. 8. In particular, FIG. 9 illustrates the operating mechanism of the first traction means tensioner 39. However, the second traction means tensioner 40 may be of identical configuration, so that the corresponding explanations also apply mutatis mutandis. In particular, the first traction means tensioner 39 may be in the form of a ring rotatable about the transmission axis 27 and having a varying radial thickness with respect to the transmission axis 27. For example, it has a minimum radial thickness a and a maximum radial thickness b. The traction means tensioner 39 may be rotatable via the pretensioning access 32, for example by means of a tool inserted through the pretensioning access 32. The first traction means tensioner 39 may be arranged between the rotary bearing 37 and the first housing 38. When the region of the first traction means tensioner 39 having the maximum radial thickness b is oriented in the direction of the input traction means pulley 30 by rotating the traction means tensioner 39, the thick region of the traction means tensioner 39 displaces the rotary bearing 37 and the transmission traction means pulley unit 41 in a direction away from the input traction means pulley 30, thereby tensioning the input traction means 28. In this way, a desired pretension can be set for the input traction means 28. FIGS. 8 and 9 show the traction mechanism unit 16 with fully tensioned traction means. As already explained, the second traction means tensioner 40 operates in an identical manner, so that the above explanations apply mutatis mutandis to the elements associated with the second traction means tensioner 40.

FIGS. 10 to 13 show various configuration options of the traction mechanism unit 16 in the region of the transmission traction means pulley unit 41. In particular, each is a top view of a horizontal cross-section through the transmission traction means pulley unit 41. On the right side of each of the illustrations, the first support unit 25 is shown as the first housing 36, and on the left side, the second support unit 26 is shown as the second housing 38. In the embodiment according to FIG. 10, a transmission traction means pulley unit 41 is shown whose input-side traction means pulley 42 and output-side traction means pulley 43 may each be configured as separate components, i.e., separate from one another. The outer circumferential surfaces of the input-side traction means pulley 42 and the output-side traction means pulley 43 may be completely encased or encapsulated or enclosed by the first housing 36 and the second housing 38, respectively. In order to implement the transmission of the drive power from the input-side traction means pulley 42 to the output-side traction means pulley 43, the transmission traction means pulley unit 41 may additionally comprise a connection unit 45, which may be connected to the input-side traction means pulley 42 and the output-side traction means pulley 43, respectively, in a co-rotating manner. Thus, the input-side traction means pulley 42 driven by the input traction means 28 can transmit the rotational motion to the connecting unit 45, which in turn can transmit the rotational motion to the output-side traction means pulley 43 and thus to the output traction means 29. FIG. 11 shows the integral configuration of the transmission traction means pulley unit 41 already shown in previous embodiment examples, in which the input-side traction means pulley 42 and the output-side traction means pulley 43 may be configured as one integral piece. Both the embodiment shown in FIG. 10 and the embodiment shown in FIG. 11 may include an inner housing 44 that rotates with the transmission traction means pulley unit 41, which may at least partially line the through opening 57. This inner housing 44 is omitted in the embodiments according to FIGS. 12 and 13. Both embodiments include integrally formed input-side traction means pulleys 42 and output-side traction means pulleys 43. However, in these embodiments, the through opening 57 may be bounded or lined by the non-rotating or frame-fixed first housing 36 and second housing 38, respectively. In the embodiment according to FIG. 13, the first housing 36 may further include a first cover 46 that may close the through opening 57 on one side. Similarly, the second housing 38 may include a second cover 47 that may close the through opening 57 on the other side. Thus, in the embodiment according to FIG. 13, the through opening 57 may be closed, i.e., not open. Another difference between the embodiments according to FIGS. 10, 11 and FIGS. 12, 13 may be that the traction means tensioners 39, 40 are arranged outside the transmission traction means pulley unit 41 in the embodiments according to FIGS. 10 and 11 and inside the transmission traction means pulley unit 41 in the embodiments according to FIGS. 12 and 13. Outside and inside here refers to a radial direction as viewed from the transmission axis 27. Thus, viewed radially outward from the transmission axis 27, in the embodiments shown in FIGS. 10 and 11, the rotary bearing 37 is followed by the traction means tensioner 39, 40, followed by the housing 36, 38. In the embodiments according to FIGS. 12 and 13, on the other hand, viewed in the same direction, the housing 36, 38 is followed by the traction means tensioner 39, 40, followed by the rotary bearing 37. Which of the described embodiments is used depends on the specific requirements.

FIG. 14 shows the connection of the traction mechanism unit 16 to the driven wheel, in this case the rear wheel 3. However, the driven wheel might as well be the front wheel 2. Specifically, FIG. 14 shows a top view of a horizontal cross-section through the rear wheel struts 8, the traction mechanism unit 16, and the rear wheel hub body 23. The output traction means pulley 31 rotates, for example, about the rear wheel axle body 24 formed by an axle stub 49 and a quick-release axle 50 and, in particular, about the rear wheel axis 15. The output traction means pulley 31 may be mounted on the frame 1, in particular on a rear wheel strut 8, via a bearing sleeve 68. The axle stub 49 and the quick-release axle 50 may together form a rear wheel axle body 24, which may likewise pass through the bearing sleeve 68. The force transmission between the output traction means pulley 31 and the rear wheel hub body 23 is effected via a form-fitting connection 52, such as a Hirth toothing. In particular, this connection is a form-fitting connection 52 that can be released axially with respect to the rear wheel axis 15. In other words, the rear wheel hub body 23 can be removed or released from the output traction means pulley 31 in axial direction of the rear wheel axis 15. To ensure that the rear wheel hub body 23 remains in operative connection with the output traction means pulley 31 in the assembled state, the rear wheel hub body 23 is pressed against the output traction means pulley 31, for example, by a radially thickened clamping portion 51 of the quick-release axle 50. In this state, the quick-release axle 50 can be fixed to the rear wheel strut 8 with the clamping portion 51 so that the operative engagement of the form-fitting connection 52 between the rear wheel hub body 23 and the output traction means pulley 31 is maintained during operation of the vehicle F.

FIG. 15 shows the situation in which the rear wheel hub body 23 is released from the output traction means pulley 31, for example to change the rear wheel 3. For this purpose, only the fixation of the quick-release axle 50 on the rear wheel strut 8 must be released. This allows the quick-release axle 50 together with the clamping portion 51 to be pulled out of the traction mechanism unit 16 and the rear wheel hub body 23. Therefore, the rear wheel hub body 23 is no longer pressed against the output traction means pulley 31 by the clamping portion 51 of the quick-release axle 50. The form-fitting connection 52 can therefore be released in the axial direction of the rear wheel axis 15, allowing the rear wheel hub body 23 and the rear wheel 3 associated therewith (not shown for clarity) to be removed from the frame 1 of the vehicle F. The traction mechanism unit 16, on the other hand, can remain on the frame 1 or on the rear wheel strut 8 together with the bearing sleeve 68. It is therefore not necessary for an end user to perform any work on the traction mechanism unit 16 when changing a driven wheel, for example the rear wheel 3. In particular, the input traction means 28 and the output traction means 29 remain in their pretensioned arrangement in the traction mechanism unit 16, which significantly simplifies removal and installation of the driven wheel.

FIG. 16 shows a flowchart of the method 60 for assembling a vehicle F and the method 65 for compensating for compression motions of a vehicle F. The methods 60, 65 may each relate to a vehicle F according to the foregoing discussion. In addition, the method 65 also relates to a vehicle F assembled according to the method 60. Although individual steps are shown sequentially in FIG. 16, they may occur simultaneously within the methods 60, 65. The method 60 for assembling a vehicle F starts with pretensioning 61 the input traction means 28 and the output traction means 29 in the traction mechanism unit 16, the pretensioning forces of the input traction means 28 and the output traction means 29 being absorbed exclusively by the support units 25, 26. This step of pretensioning 61 may be performed on the modular traction mechanism unit 16 before it is mounted on the vehicle F. In particular, the frame 1 of the vehicle F is not necessary to pretension the traction means 28, 29. All the resulting tensions are absorbed by the support units 25, 26. The next step therefore consists in installing 62 the modular traction mechanism unit 16 on the vehicle F. Thus, it is not until this step that a connection is established between the traction mechanism unit 16 and the vehicle F or the frame 1 of the vehicle F. During installing 62, compensating 63 for tolerances may be performed by pivoting 64 the support units 25, 26 about the transmission axis 27. In other words, the same traction mechanism unit 16 can be used on vehicles F with different distances between the drive axis 14 and the driven wheel axis, for example the rear wheel axis 15 or the front wheel axis 33. The different distances are compensated for by pivoting 64 the support units 25, 26 relative to each other. This makes the use of the traction mechanism unit 16 particularly variable. An essential point of the method 60 according to the invention is that the traction mechanism unit 16 can be installed with fully pretensioned traction means 28, 29 as an independent modular unit. It can be made fully operational separately from the rest of the vehicle F, in particular the frame 1, and then only needs to be mounted to the frame 1. The method 65 for compensating for compression motions of a vehicle F begins with compressing 66 the suspension of the rear wheel 3 or the front wheel 2. In particular, this wheel is the driven wheel of the vehicle F. The traction mechanism unit 16 described above then allows for compensating 67 for a change in distance between the input traction means pulley 30 and the output traction means pulley 31 caused by the compression motion by pivoting 64 the support units 25, 26 about the transmission axis 27 and simultaneously moving 69 the support units 25, 26, such that the transmission axis 27 moves relative to the frame 1. In this way, pedal kickback occurring in conventional vehicles F, in particular bicycles, can be compensated for or avoided by the traction mechanism unit 16.

The comparison shown in FIGS. 17 and 18 between a vehicle F with a drive train known from the prior art (FIG. 17; prior art) with traction means (for example chain) and traction means tensioner and the structure according to the invention with a two-stage traction mechanism unit 16 according to the invention (FIG. 18 refers specifically to the structure already described in detail with respect to FIG. 1) illustrates the advantages achieved with the invention, in particular with regard to antisquat behavior. For further illustration, a rider is also indicated in phantom lines. The so-called antisquat line AS is known to be defined by a front vertical line through the front wheel axis and a rear vertical line through the rear wheel axis. The intersection point of the front vertical line with a horizontal line at the height of the overall center of gravity S of the driver and the vehicle and the intersection point of the rear vertical line with the lower foot point of the rear wheel define the slope of the antisquat line AS. This already illustrates that the antisquat line AS is not inherently static relative to the vehicle frame, but may vary, for example, depending on the position of the overall center of gravity, depending on the rider and/or his position, depending on the suspension state, etc., for one and the same vehicle F. In the practical construction of such vehicles, the aim is now to arrange the intersection point of the traction means and the intersection point of the swing arm rotation point of the rear wheel strut 8 as much as possible on the antisquat line AS and ideally even to position them on top of each other. FIG. 17 further shows that the antisquat conditions change at the rear wheel for each gear of the derailleur system known per se in the prior art.

In comparison, the invention shown in FIG. 18 now provides the optimum solution, in particular also with regard to the antisquat behavior of the vehicle 1. Due to the force decoupling of the traction gear or of the traction mechanism unit 16 from the frame 1 of the vehicle F, in particular also comprising the rear wheel strut 8, which in the present embodiment example is adjustable relative to the rest of the frame, and the two-stage and articulated configuration of the traction mechanism unit 16, as already described above, it is possible, for example, to compensate for changes in distance between the drive axis 14 and the rear wheel axis 15 for different compression and decompression positions of the rear wheel strut 8 by changing the articulation angle between the two support units 25 and 26, without, however, having a feedback effect on the two traction means of the traction mechanism unit 16. In addition to the possibility of obtaining significantly optimized and even selectively adjustable antisquat properties, this also allows considerably greater construction freedom, especially with regard to the articulation of the rear wheel swing arm, because in particular the intersection point of a traction means per se with the antisquat line AS no longer plays a role in the present structure.

What is claimed is:

1-27. (canceled)

28. A single or multi-track vehicle of the type bicycle, pedelec, e-bike or bicycle with auxiliary drive, comprising:
at least one front wheel and at least one rear wheel, which are connected to one another via a frame, the front wheel being mounted on the frame for rotation about a front wheel axis and the rear wheel being mounted on the frame for rotation about a rear wheel axis; and
a traction mechanism unit comprising:
an input traction means driven by an input traction means pulley; and
an output traction means driving an output traction means pulley,
wherein said input traction means and said output traction means are arranged in series with one another and are in transmission connection with one another via a transmission traction means pulley unit, said transmission traction means pulley unit comprising an input-side traction means pulley engaged with said input traction means and an output-side traction means pulley engaged with said output traction means, said input-side traction means pulley and said output-side traction means pulley being rotatable about a common transmission axis,
the output traction means pulley being driven by a drive shaft connected to pedals and/or a drive unit and the rear wheel or the front wheel is driven by the output traction means pulley, wherein:
a first support unit supporting the input traction means pulley and the input-side traction means pulley is provided for absorbing tensioning forces of the input traction means independently of the frame;
wherein a second support unit supporting the output-side traction means pulley and the output traction means pulley is provided for absorbing tensioning forces of the output traction means independently of the frame;
wherein the frame absorbs wheel contact forces occurring during operation of the vehicle bypassing the first support unit and the second support unit;
wherein the first support unit and the second support unit are configured to be rotatable relative to each other; and
wherein the first support unit and the second support unit are rotatably mounted on the frame.

29. The vehicle according to claim 28, wherein the input-side traction means pulley and the output-side traction means pulley are arranged coaxially to the transmission axis.

30. The vehicle according to claim 28, wherein the input-side traction means pulley and the output-side traction means pulley are configured in a co-rotating manner relative to one another and, in particular, as one integral piece.

31. The vehicle according to claim 28, wherein the transmission ratio from the input-side traction means pulley to the output-side traction means pulley and/or from the input traction means pulley to the output traction means pulley and/or from the input traction means pulley to the input-side traction means pulley and/or from the output-side traction means pulley to the output traction means pulley is one to one.

32. The vehicle according to claim 28, wherein the first support unit includes a first housing and/or the second support unit includes a second housing, the housings in particular being made of plastic and encapsulating, in particular completely, the input traction means and the output traction means, respectively.

33. The vehicle according to claim 28, wherein the first support unit is formed, in particular completely, by the first housing, so that the latter is configured to absorb the tensioning forces of the input traction means, in particular completely, and/or in that the second support unit is formed, in particular completely, by the second housing, so that the latter is configured to absorb the tensioning forces of the output traction means, in particular completely.

34. The vehicle according to claim 28, wherein the first support unit includes a first traction means tensioner for pretensioning the input traction means and/or in that the second support unit includes a second traction means tensioner for pretensioning the output traction means, the first and/or the second traction means tensioner being configured in particular as an eccentric traction means tensioner.

35. The vehicle according to the claim 34, wherein the first and/or the second traction means tensioner are arranged on the transmission traction means pulley unit, wherein in particular at least one pretensioning access is provided through which the first and/or the second traction means tensioner is accessible from the outside for setting a pretensioning position.

36. The vehicle according to claim 34, wherein the transmission traction means pulley unit is mounted on the first support unit and/or the second support unit via a rotary bearing, and in that the first and/or the second traction means tensioner is arranged inside or outside this rotary bearing.

37. The vehicle according to claim 28, wherein the input traction means and/or the output traction means is configured as a belt, in particular a toothed belt.

38. The vehicle according to claim 28, wherein a brake device having a brake caliper and a brake disc is provided, the brake caliper and/or the brake disc being mounted on the traction mechanism unit, the brake disc being arranged in particular coaxially with the input traction means pulley or the output traction means pulley or the transmission traction means pulley unit, and the brake caliper being mounted in particular on the housing of the traction mechanism unit.

39. The vehicle according to claim 28, wherein the traction mechanism unit has at least one of the following features:
it comprises a speed sensor, the speed sensor being arranged in particular on the input traction means pulley or the output traction means pulley or the transmission traction means pulley unit;
it comprises an electric generator for recovering drive energy as electric energy;
it comprises a suspension travel sensor which measures a rotation of the support units relative to each other or a rotation of the front support unit relative to the frame or motor.

40. The vehicle according to claim 28, wherein the traction mechanism unit has at least one of the following features:
the transmission traction means pulley unit, and in particular also the housings of the support units, comprises a through opening which extends through the traction mechanism unit and is open to the outside;
the through opening is formed coaxially to the transmission axis;
the through opening is bounded in radial direction of the transmission axis by an inner housing;
the inner housing is connected to the transmission traction means pulley unit in a co-rotating manner and is rotatable therewith;
at least one lighting device is arranged in the region of the through opening, which in particular illuminates the inner housing.

41. The vehicle according to claim 28, wherein the traction mechanism unit is configured such that it absorbs tensioning forces of the at least two traction means completely decoupled from the frame and transmits torque forces introduced into the traction mechanism unit via an input traction means pulley to the output traction means pulley in isolation from the frame.

42. The vehicle according to claim 28, wherein the first support unit is mounted on the frame such that it can rotate about a drive axis of the vehicle and/or in that the second support unit is mounted on the frame such that it can rotate about the rear wheel axis or the front wheel axis of the vehicle, the traction mechanism unit in particular being mounted on the frame exclusively via these mounting points.

43. The vehicle according to claim 42, wherein the input traction means pulley is arranged coaxially to the drive axis of the vehicle and/or in that the output traction means pulley is arranged coaxially to the rear wheel axis or the front wheel axis of the vehicle.

44. The vehicle according to claim 41, wherein the transmission axis is arranged vertically above or below the drive axis and/or the rear wheel axis or the front wheel axis of the vehicle.

45. The vehicle according to claim 28, wherein the second support unit is arranged offset from the first support unit toward the center of the vehicle in the direction of the rear wheel axis or the front wheel axis.

46. The vehicle according to claim 28, wherein it has at least one of the following features:
the rear wheel and/or the front wheel includes a set of spokes symmetrical about a symmetry axis;
the rear wheel is connected to at least one rear wheel strut or rear wheel swing arm belonging to the frame;
the rear wheel strut is connected to the rest of the frame, in particular a seat tube, such that it can rotate about a strut bearing;
the rear wheel strut is bent vertically upward and extends around the traction mechanism unit, in particular vertically above the traction mechanism unit;
the rear wheel is suspended on the frame, in particular indirectly via the rear wheel strut, via a damper;
the strut bearing is arranged offset from the frame-side rotation axis of the first support unit;
the strut bearing is arranged vertically above the frame-side rotation axis of the first support unit, for example the drive axis.

47. The vehicle according to claim 28, wherein the traction mechanism unit has a modular configuration as a coherent structural unit that can be removed from or mounted on the vehicle together with a brake disc and/or a brake caliper, the structural unit being configured in particular such that the input traction means and/or the output traction means can be pretensioned irrespective of whether the structural unit is mounted on the vehicle.

48. The vehicle according to claim 28, wherein the output traction means pulley is connected to a rear wheel hub body or a front wheel hub body via an axially releasable form-fitting connection acting in the direction of rotation, in particular a Hirth toothing.

49. The vehicle according to the claim 48, wherein the rear wheel hub body and/or the front wheel hub body is configured to be dismountable from the output traction means pulley via the form fit such that the rear wheel hub body and/or the front wheel hub body can be dismounted from the vehicle together with the rear wheel or the front wheel, respectively, while the traction mechanism unit with the output traction means pulley, and in particular the brake disc and/or the brake caliper, remains on the frame.

50. A method for assembling the vehicle according to claim 28, the vehicle comprising a modular traction mechanism unit having a first support unit with an input traction means and a second support unit with an output traction means, the two support units being connected to each other in an articulated manner and being pivotable relative to each other about a common transmission axis, the method comprising the steps of:
a) pretensioning the input traction means and the output traction means in the traction mechanism unit, the pretensioning forces of the input traction means and the output traction means being absorbed exclusively by the support units;
b) installing the modular traction mechanism unit on the vehicle; and
c) compensating for tolerances by pivoting the support units about the transmission axis.

51. A method for avoiding pedal kickback in a vehicle, the vehicle having a frame, a suspended rear wheel or a suspended front wheel and a modular traction mechanism unit having a first support unit with an input traction means and a second support unit with an output traction means, the two support units being connected to each another in an articulated manner and being pivotable relative to one another about a common transmission axis, and the traction mechanism unit transmitting drive energy from an input traction means pulley to an output traction means pulley, the method comprising the steps of:
a) compressing the suspension of the rear wheel or the front wheel; and
b) compensating for a change in distance between the input traction means pulley and the output traction means pulley caused by the compression motion by pivoting the support units about the transmission axis and simultaneously moving the support units, such that the transmission axis moves relative to the frame.

52. A method for transmitting a drive torque of a single-track or multi-track vehicle via a traction mechanism unit, in the vehicle according to claim 28, comprising the following steps:
absorbing tensioning forces of a traction mechanism unit in isolation from a frame;
introducing torque forces via an input traction means pulley into the traction mechanism unit;
transmitting the torque forces to an output traction means pulley in isolation from the frame via at least two traction means, in particular arranged in series with each other; and
diverting the torque forces via the output traction means pulley to drive the front or rear wheel.

53. A method for eliminating interaction between a drive train with a traction mechanism unit and a suspension/damping device in a single- or multi-track vehicle, in particular a bicycle, pedelec, e-bike or bicycle with auxiliary drive, according to claim 28,
with a front wheel and at least one rear wheel, which are connected to one another via a frame comprising a main frame and a wheel strut pivotably mounted thereon, the front wheel being mounted for rotation about a front wheel axis and the rear wheel being mounted for rotation about a rear wheel axis, and the front wheel or the rear wheel being mounted on the main frame via the wheel strut,
with a traction mechanism unit having at least two traction means, in particular arranged in series with one another, in particular a traction mechanism unit according to claim 28,
the traction means gear unit being in drive connection between a drive axis and a rotation axis of the front wheel or the rear wheel, comprising the steps of:
pivoting the wheel strut and the wheel mounted thereon relative to the main frame in a damped manner with the aid of the suspension/damping device;
transmitting the drive torques independently of tensioning forces of the traction means and the pivoting of the wheel strut and the wheel mounted thereon relative to the main frame; and
compensating for distance changes between the input axis and the rotation axis by a rotation of a first support unit of an input traction means relative to a second support unit of an output traction means of the traction mechanism unit.

54. A traction mechanism unit for a single- or multi-track vehicle, in particular a bicycle, pedelec, e-bike or bicycle with auxiliary drive, comprising:
an input traction means driven by an input traction means pulley;
an output traction means driving an output traction means pulley; and
said input traction means and said output traction means being arranged in series with one another and being in transmission connection with one another via a transmission traction means pulley unit, said transmission traction means pulley unit comprising an input-side traction means pulley engaged with said input traction means and an output-side traction means pulley engaged with said output traction means, said input-side traction means pulley and said output-side traction means pulley being coaxially rotatable relative to each other, wherein:
a first support unit supporting the input traction means pulley and the input-side traction means pulley is provided for absorbing the tensioning forces of the input traction means, and wherein a second support unit supporting the output-side traction means pulley and the output traction means pulley is provided for absorbing the tensioning forces of the output traction means;
the first support unit and the second support unit being configured to be rotatable relative to each other;
the first support unit including a first traction means tensioner for pretensioning the input traction means and/or the second support unit including a second traction means tensioner for pretensioning the output traction means, the first and/or the second traction means tensioner being configured as an eccentric traction means tensioner; and
the first and/or the second traction means tensioner being arranged on the transmission traction means pulley unit, wherein in particular at least one pretensioning access is provided through which the first and/or the second traction means tensioner is accessible from the outside for setting a pretensioning position.
